(19) United States
(12) Patent Application Publication
(10) Pub. No.: US 2026/0313696 A1
(43) Pub. Date: Oct. 8, 2026

(54) UPLINK AND DOWNLINK SPATIAL DIRECTION INDICATION DURING RANDOM ACCESS

(71) Applicant: QUALCOMM Incorporated, San Diego, CA (US)

(72) Inventors: In-Soo KIM, San Diego, CA (US); Yan ZHOU, San Diego, CA (US); Jing SUN, San Diego, CA (US); Jing JIANG, San Diego, CA (US)

(21) Appl. No.: 19/169,616

(22) Filed: Apr. 3, 2025

(51) Int. Cl. H04W 74/0833; H04W 48/08

(52) U.S. Cl. CPC H04W 74/0833; H04W 48/08

(57) ABSTRACT

Various aspects of the present disclosure generally relate to wireless communication. In some aspects, a network entity may transmit, during a random access procedure, a first indication of a first synchronization signal block (SSB) index, wherein the first SSB index indicates first spatial direction information for downlink. The network entity may transmit, during the random access procedure, a second indication of a second SSB index, wherein the second SSB index indicates second spatial direction information for uplink. Numerous other aspects are described.

### FIELD OF THE DISCLOSURE

Aspects of the present disclosure generally relate to wireless communication and specifically relate to techniques, apparatuses, and methods associated with uplink and downlink spatial direction indication during random access.

### INTRODUCTION

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a network entity. The network entity may include a processing system. The processing system may be configured to transmit, during a random access procedure, a first indication of a first synchronization signal block (SSB) index, wherein the first SSB index indicates first spatial direction information for downlink. The processing system may be configured to transmit, during the random access procedure, a second indication of a second SSB index, wherein the second SSB index indicates second spatial direction information for uplink.

Some aspects described herein relate to a network entity. The network entity may include a processing system. The processing system may be configured to receive, during a random access procedure, a first indication of a first SSB index, wherein the first SSB index indicates first spatial direction information for downlink. The processing system may be configured to receive, during the random access procedure, a second indication of a second SSB index, wherein the second SSB index indicates second spatial direction information for uplink.

Some aspects described herein relate to a method of wireless communication performed by a network entity. The method may include transmitting, during a random access procedure, a first indication of a first SSB index, wherein the first SSB index indicates first spatial direction information for downlink. The method may include transmitting, during the random access procedure, a second indication of a second SSB index, wherein the second SSB index indicates second spatial direction information for uplink.

Some aspects described herein relate to a method of wireless communication performed by a network entity. The method may include receiving, during a random access procedure, a first indication of a first SSB index, wherein the first SSB index indicates first spatial direction information for downlink. The method may include receiving, during the random access procedure, a second indication of a second SSB index, wherein the second SSB index indicates second spatial direction information for uplink.

Some aspects described herein relate to an apparatus for wireless communication. The apparatus may include means for transmitting, during a random access procedure, a first indication of a first SSB index, wherein the first SSB index indicates first spatial direction information for downlink. The apparatus may include means for transmitting, during the random access procedure, a second indication of a second SSB index, wherein the second SSB index indicates second spatial direction information for uplink.

Some aspects described herein relate to an apparatus for wireless communication. The apparatus may include means for receiving, during a random access procedure, a first indication of a first SSB index, wherein the first SSB index indicates first spatial direction information for downlink. The apparatus may include means for receiving, during the random access procedure, a second indication of a second SSB index, wherein the second SSB index indicates second spatial direction information for uplink.

Some aspects described herein relate to a non-transitory computer-readable medium having code stored thereon. The code, when executed by a network entity, may cause the network entity to transmit, during a random access procedure, a first indication of a first SSB index, wherein the first SSB index indicates first spatial direction information for downlink. The code, when executed by a network entity, may cause the network entity to transmit, during the random access procedure, a second indication of a second SSB index, wherein the second SSB index indicates second spatial direction information for uplink.

Some aspects described herein relate to a non-transitory computer-readable medium having code stored thereon. The code, when executed by a network entity, may cause the network entity to receive, during a random access procedure, a first indication of a first SSB index, wherein the first SSB index indicates first spatial direction information for downlink. The code, when executed by a network entity, may cause the network entity to receive, during the random access procedure, a second indication of a second SSB index, wherein the second SSB index indicates second spatial direction information for uplink.

Aspects generally include a method, apparatus, system, computer program product, non-transitory computer-readable medium, user equipment, base station, network entity, network node, wireless communication device, or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

FIG. 1 is a diagram illustrating an example environment in which apparatuses or methods described herein may be implemented.

FIG. 2 is a diagram illustrating an example of a wireless communication network.

FIG. 3 is a diagram illustrating an example of a two-step random access procedure.

FIG. 4 is a diagram illustrating an example of a four-step random access procedure.

FIG. 5 is a diagram illustrating an example of uplink and downlink beam indications.

FIG. 6 is a diagram illustrating an example associated with uplink and downlink spatial direction indication during random access.

FIG. 7 is a diagram illustrating an example of uplink and downlink beam indications during a random access procedure.

FIG. 8 is a diagram illustrating an example of uplink and downlink beam refinement during a random access procedure.

FIG. 9 is a diagram illustrating an example process performed, for example, at a network entity or an apparatus of a network entity.

FIG. 10 is a diagram illustrating an example process performed, for example, at a network entity or an apparatus of a network entity.

FIG. 11 is a diagram of an example apparatus for wireless communication.

FIG. 12 is a diagram of an example apparatus for wireless communication.

### DETAILED DESCRIPTION

A first network entity (such as a user equipment (UE)) in some wireless communication systems may perform one or more procedures for establishing a communications link with a second network entity (such as a network node) that is operating as part of a wireless communication network. The first network entity may communicate a series of messages with the second network entity to establish access to the network. In some examples, establishing access to the network may be referred to as initial access. In some examples, the first network entity may perform a random access procedure to establish access to the wireless communication network via the second network entity (e.g., to establish a communication connection including an uplink connection or a downlink connection). In some examples, the random access procedure may also be referred to as a random access channel (RACH) procedure. In some examples, the first network entity may perform a random access procedure, such as a four-step random access procedure or a two-step random access procedure. In some examples, the first network entity may perform a random access procedure (e.g., a RACH procedure) with a second network entity to enable the first network entity to establish a connection with the second network entity, such as for an initial access, a link recovery, or a beam failure recovery, among other examples.

In some examples, network entities may communicate using multiple input multiple output (MIMO) systems and advanced beamforming techniques to enhance signal reception and transmission. For example, a network entity (e.g., a network node) may transmit one or more synchronization signal blocks (SSBs), where each SSB corresponds to a specific beam direction or spatial direction. Another network entity (e.g., a UE) may measure the one or more SSBs to determine a best spatial direction (e.g., a best beam) to use for communication with the network entity (e.g., the network node).

In some examples, a protocol for beam determination may be established based on single-port SSBs, which implies that the most suitable SSB for both uplink and downlink communications is identified by the highest measurement value, such as a highest reference signal received power (RSRP). Therefore, a network entity (e.g., a UE) indicating a single SSB for both uplink and downlink during a random access procedure is considered sufficient. However, the adoption and implementation of multi-port SSBs is anticipated for future wireless communication networks. Such systems can leverage cross-polarized antennas at a network node, which implies a minimum of two ports including at least one horizontal port and at least one vertical port.

This anticipated complexity in SSB configuration poses a challenge where the optimal spatial direction (e.g., beam) for downlink may not coincide with the optimal spatial direction (e.g., beam) for uplink. For example, the transmission power available for uplink transmission may be less than that for downlink transmission, leading to scenarios where the selection of SSBs based on power gain may be more indicative for uplink, whereas the choice of SSBs based on rank may be more indicative for downlink.

In the context of single-port SSBs, the optimal SSB for downlink communication may not necessarily be the optimal SSB for uplink communication due to radio frequency (RF) regulations. For example, an RSRP of first SSB 1 may greater than an RSRP of second SSB 2 for downlink communication. However, if a human body obstructs the path of the propagation link of the first SSB, the uplink transmission in the propagation link of first SSB may be transmitted with reduced power to comply with RF exposure limits, such as maximum permissible exposure (MPE) or specific absorption rate (SAR) constraints. Consequently, the propagation link of the second SSB may have better performance for uplink transmission due to the absence of such power backoff requirements. Conversely, for downlink reception, the propagation link of the first SSB may have better performance.

Current wireless communication protocols do not support separate uplink and downlink SSB indications within a random access procedure, which can result in suboptimal beam selection and an inability to fully exploit the advantages of having multiple ports available at the network node. Moreover, existing mechanisms to indicate the optimal spatial directions (e.g., beams) for uplink and downlink are cumbersome and slow, as they require additional beam sweep processes after a random access procedure has been completed, involving a series of messages that delay the complete establishment of the best communication beams. This can increase latency associated with identifying, selecting, or using a best uplink beam and a best downlink beam for communication between two network entities.

Various aspects relate generally to a random procedure that includes spatial direction information (e.g., beam indications) for both uplink and downlink. Some aspects more specifically relate to a network entity transmitting, during a random access procedure, a first indication of a first SSB index for downlink. The network entity may transmit a second indication of a second SSB index for uplink during the random access procedure. In some aspects, the network entity may transmit a first random access message during a RACH occasion (RO) associated with the first SSB index. The network entity may transmit a second random access message (e.g., a Msg3) that includes the second SSB index indication.

In some aspects, the network entity may receive an indication to apply the spatial direction information for both downlink and uplink communications, based on the transmitted SSB indices (e.g., during the random access procedure). In some aspects, the network entity may receive configuration information associated with a first channel state information (CSI) reference signal (CSI-RS) resource set or a second CSI-RS set. The first CSI-RS resource set may be configured for uplink beam refinement and the second CSI-RS resource set may be configured for downlink beam refinement. For example, the network entity may indicate first spatial direction information (e.g., a first beam) for uplink via an SSB index. The first beam may be a wide beam. The network entity may indicate second spatial direction information (e.g., a second beam) for uplink via measurement information or a beam report based on measurements of the first CSI-RS resource set. The second beam may be a narrow beam.

A “wide” beam is a radio frequency (RF) beam that covers a broad area with a relatively large beamwidth. Wide beams may be used for initial signal acquisition, broadcasting, and scenarios where coverage is prioritized over precision. Wide beams may be less focused and have a larger angular spread, making them suitable for reaching multiple UEs within a wide area. Wide beams may have a large beamwidth (such as greater than 10 degrees) and a large coverage area (e.g., which can be quantified in terms of square meters or square kilometers). Additionally, wide beams typically have lower antenna gain compared to narrow beams. A “narrow” beam is a focused RF beam with a small beamwidth. Narrow beams are used for targeted communication with specific UEs, providing higher signal strength and reduced interference. Narrow beams are more focused and have a smaller angular spread, making them suitable for high-precision applications and scenarios where signal quality and strength are valued. Narrow beams may have a smaller beamwidth (such as less than 10 degrees) and a smaller coverage area (e.g., which can be quantified in terms of square meters). Narrow beams may have higher antenna gain compared to wide beams.

Particular aspects of the subject matter described can be implemented to realize one or more potential technical advantages. By a first network entity transmitting separate SSB indices for uplink and downlink, the described techniques can enable a second network entity to obtain separate spatial direction information (e.g., separate beams) for uplink and downlink prior to establishing a radio resource control (RRC) connection. This reduces the latency associated with the first network entity and the second network entity communicating using the best spatial direction information for uplink and downlink. Additionally, this enables optimized beamforming performance by making use of multiple ports at a network entity equipped with cross-polarized antennas, thereby improving spectrum efficiency and enhancing network capacity. In some aspects, by the second network entity utilizing first and second CSI-RS resource sets (e.g., that are configured based on the indicated spatial direction information that is based on indicated SSB indices), the described techniques can enable the first network entity and the second network entity to refine the spatial direction information for both downlink and uplink. This enables the selection of more precise beam directions, which can improve communication performance by enhancing signal quality and reducing interference.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence devices). Aspects may be implemented in chip-level components, modular components, non-modular components, non-chip-level components, device-level components, or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, or summers). Aspects described herein may be practiced in a wide variety of devices, components, systems, distributed arrangements, or end-user devices of varying size, shape, and constitution.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

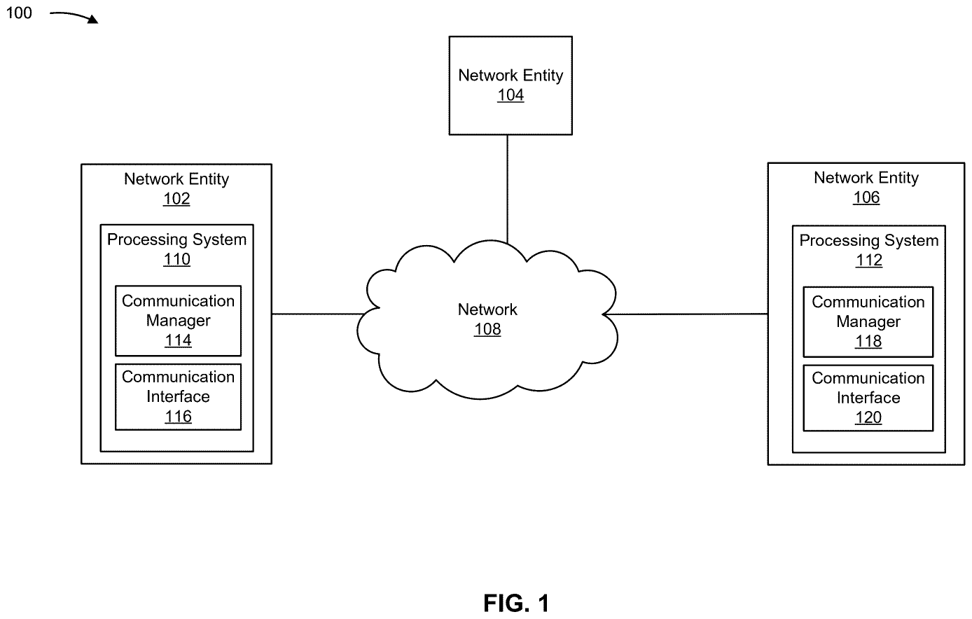

FIG. 1 is a diagram illustrating an example environment 100 in which apparatuses or methods described herein may be implemented. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary or mobile. The network 108 may include wired communication connections, wireless communication connections, or a combination of wired and wireless communication connections.

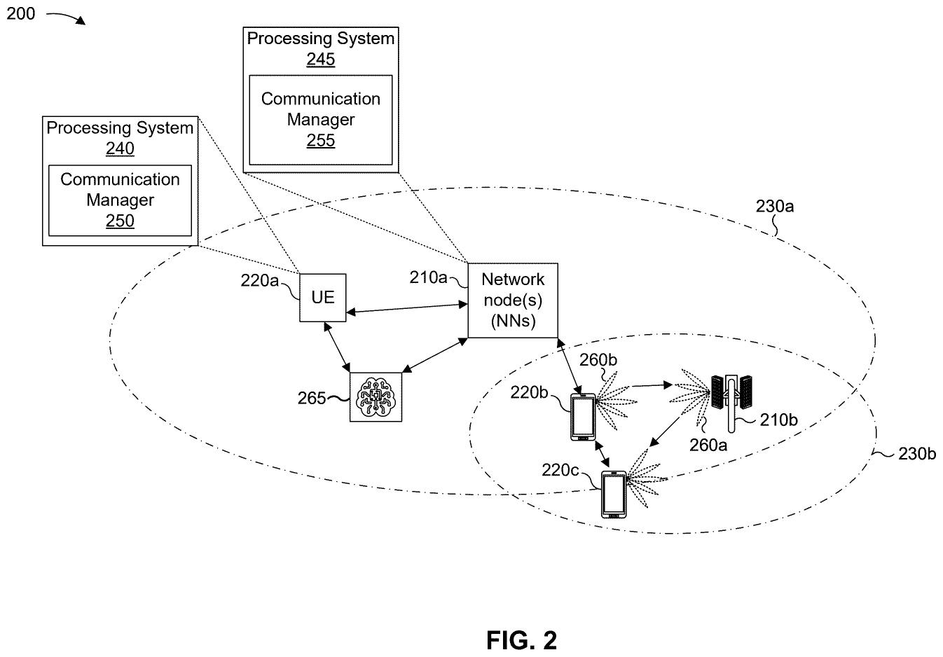

The network 108 may include, for example, a cellular network (e.g., a Long-Term Evolution (LTE) network, a CDMA network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in or currently operating in the network. Rather, a network entity may be any entity that is capable of communicating or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, or a second processing entity, among other examples.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, or a third component configured to provide the output information to other systems or components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a processing system may include at least one memory, at least one communication interface, or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, or a third component configured to output the one or more outputs to one or more other components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, or a transceiver, among other examples. For example, a communication interface may include one or more transceivers, one or more receivers, or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, or a modulation component, among other examples.

A communication interface may include a transmission component or a reception component. For example, a communication interface may include a transceiver or one or more separate receivers or transmitters that enable a network entity to communicate with other devices, such as via a wired connection, a wireless connection, or a combination of wired and wireless connections. In some examples, a communication interface may include one or more radio frequency reflective elements or one or more radio frequency refractive elements. The communication interface may enable the network entity to receive information from another apparatus or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), or a serial peripheral interface (SPI), among other examples.

As described herein, a network entity (e.g., the network entity 102 or the network entity 106) may be configured to perform one or more operations. Reference to a network entity being configured to perform one or more operations may refer to a processing system of the network entity being configured to perform the one or more operations or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, or at least one communication interface, among other examples, that are configured to perform one or more (or all) of the one or more operations, or any combination thereof. Where reference is made to the network entity or the processing system being configured to perform operations, the network entity or the processing system may be configured to cause one component to perform all operations, or to cause more than one component to collectively perform the operations. When the network entity or the processing system is configured to cause more than one component to collectively perform the operations, each operation need not be performed by each of those components (e.g., different operations may be performed by different components) or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 and/or the communication interface 116 to) transmit, during a random access procedure, a first indication of a first SSB index, wherein the first SSB index indicates first spatial direction information for downlink; and transmit, during the random access procedure, a second indication of a second SSB index, wherein the second SSB index indicates second spatial direction information for uplink. Additionally, or alternatively, the network entity 102 and/or the communication manager 114 may perform one or more other operations described herein.

As described in more detail elsewhere herein, the network entity 106 may (e.g., the processing system 112 may, or the processing system 112 may cause the communication manager 118 and/or the communication interface 120 to) receive, during a random access procedure, a first indication of a first SSB index, wherein the first SSB index indicates first spatial direction information for downlink; and receive, during the random access procedure, a second indication of a second SSB index, wherein the second SSB index indicates second spatial direction information for uplink. Additionally, or alternatively, the network entity 106 and/or the communication manager 118 may perform one or more other operations described herein.

The number and arrangement of entities shown in FIG. 1 are provided as one or more examples. In practice, there may be additional network entities or networks, fewer network entities or networks, different network entities or networks, or differently arranged network entities or networks than those shown in FIG. 1. Furthermore, the network entity 102, 104, and 106 may be implemented using a single apparatus or multiple apparatuses.

FIG. 2 is a diagram illustrating an example of a wireless communication network 200. The wireless communication network 200 may be or may include elements of a 5G network or a 6G network, among other examples. The wireless communication network 200 may include multiple network nodes 210. For example, in FIG. 2, the wireless communication network 200 includes multiple network nodes 210, including a network node 210a and a network node 210b (each of which also may be referred to herein simply as a “network node 210”). The network nodes 210 may support communications with multiple UEs 220. For example, in FIG. 2, the network nodes 210 support communication with a UE 220a, a UE 220b, and a UE 220c (each of which also may be referred to herein simply as a “UE 220”). In some examples, a UE 220 also may communicate with other UEs 220 and a network node 210 also may communicate with a core network and with other network nodes 210. A network node 210 and a UE 220 may be examples of a network entity described herein, such as the network entity 102, the network entity 104, or the network entity 106.

The network nodes 210 and the UEs 220 of the wireless communication network 200 communicate using the electromagnetic spectrum, which may be subdivided into various licensed or unlicensed operating bands, frequency ranges, component carriers, or channels that define associated frequencies available for communications. In some examples, each of the network nodes 210 and the UEs 220 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR 4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 210 or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system. As shown in FIG. 2, each UE 220 includes a processing system 240 and each network node 210 includes a processing system 245. A processing system (for example, the processing system 240 or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 or the processing system 245 may include or implement one or more of the modems. The processing system 240 and the processing system 245 also may include or be coupled with multiple radios (collectively “the radio”), multiple RF chains, or multiple transceivers, each of which may in turn be coupled with one or more of multiple antennas. In some examples, one or more processors of the processing system 240 or the processing system 245 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 240 or by the processing system 245).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 210 and the UE 220.

A network node 210 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may include a single standalone base station or a single TRP that operates with a full radio protocol stack to enable or facilitate communication between a UE 220 and a core network of the wireless communication network 200.

Alternatively, and as also shown, a network node 210 may be a disaggregated network node 210 (sometimes referred to as a disaggregated base station), having a disaggregated architecture, meaning that the network node 210 may operate with a radio protocol stack that is physically distributed or logically distributed among two or more nodes in the same geographic location or in different geographic locations. In some deployments, disaggregated network nodes 210 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 210 of the wireless communication network 200 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 200 may be a heterogeneous network that includes network nodes 210 of various types. Different types of network nodes 210 may generally operate on the same or different operating bands, transmit at different power levels, or serve different coverage areas, each of which may be referred to as or associated with a particular cell 230 (for example, a cell 230a and a cell 230b).

The UEs 220 may be physically dispersed throughout the coverage area of the wireless communication network 200, and each UE 220 may be stationary or mobile. A UE 220 may be, may include, or also may be referred to as an access terminal, a mobile station, a client device, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 200.

Some UEs 220 may be classified according to different categories in association with different complexities or different capabilities. UEs 220 in a first category may be associated with relatively low complexity or cost such as NB-IoT devices or eMTC UEs. UEs 220 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 200. A third category of UEs 220 may have mid-tier complexity or capabilities (for example, capabilities between that of the UEs 220 of the first category and the UEs 220 of the second category). A UE 220 of the third category may be referred to as a reduced capability UE (“RedCap UE”), a mid-tier UE, an NR-Light UE, or an NR-Lite UE, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) or reconfigured (for example, in real-time or near-real-time) according to changing network conditions in the wireless communication network 200 or specific requirements of one or more UEs 220. An active BWP defines the operating bandwidth of the UE 220 within the operating bandwidth of the serving cell.

In some examples, a UE 220 may perform a random access procedure (e.g., a RACH procedure) with a network node 210 to enable the UE 220 to establish a connection with the network node, such as for an initial access, a link recovery, or a beam failure recovery, among other examples. The RACH procedure may include the exchange of one or more random access messages between the UE and the network node. For example, the UE may transmit a preamble, such as a PRACH preamble. In some examples, the UE 220 may utilize resources that are configured (such as via system information signaling) for initiating random access procedures with the network node 210. As part of the random access procedure, the UE 220 may transmit a random access message (RAM) that includes the preamble. The UE 220 may transmit the RAM via a RACH. The network node 210 may transmit, and the UE 220 may receive, an RAR. The UE 220 can use the RAR to perform synchronization and establish a communication connection with the network node. A random access procedure may include a two-step random access procedure, a three-step random access procedure, a four-step random access procedure, or another type of random access procedure. The random access procedure may enable the network node to manage network resources efficiently by ensuring that multiple UEs 220 can simultaneously and reliably request access to the wireless communication network, such as in dense environments or deployments.

Advancements in random access procedures may enable enhanced efficiency, reduced latency, scalability, or performance, among other examples, in the wireless communication network 200. For example, the UE 220 and the network node 210 may perform a beam refinement operation during the random access procedure to improve the quality of an initial connection between the UE 220 and the network node 210, such as by the UE 220 transmitting channel state information for one or more synchronization signal blocks (SSBs) transmitted by the network node 210 as part of the random access procedure. Other advancements for random access procedures include selective or dynamic monitoring of one or more RACH resources by the network node 210 (e.g., for improved network energy savings), repetitions of one or messages during a random access procedure (e.g., to improve coverage or reliability), preamble partitions (e.g., to group random access preambles into partitions dedicated for respective capabilities, functions, or device types), support for NTNs (e.g., random access preambles dedicated for NTN, or timing advance or frequency pre-compensation performed by the UE 220 prior to initiating a random access procedure), support for IoT devices (e.g., preamble sequences optimized for IoT networks, a dedicated control channel for random access procedures, power control mechanisms to adjust transmission power based on an estimated channel quality or network congestion, or AI/ML-based congestion prediction for IoT networks to adjust a configuration for random access procedures by the network node 210), support for multi-user random access (e.g., such as non-orthogonal multiple access (NOMA)), or one or more AI/ML techniques (e.g., preamble selection by the UE 220 using an AI/ML model), among other examples.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220 or may transmit, to the UE 220, an indication of an MCS to be applied for an uplink signal.

A network node 210 or a UE 220 (such as by using the processing system 245 or the processing system 240, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 210 or the UE 220 (for example, using the processing system 245 or the processing system 240, respectively, or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 or one or more modems) may further perform spatial processing (for example, precoding) on the encoded information to generate one or more processed or precoded signals for downlink or uplink transmission, respectively. In some examples, the network node 210a or the UE 220a may perform codebook-based precoding or non-codebook-based precoding. Codebook-based precoding may involve selecting a precoder (for example, a precoding matrix) using a codebook. For example, the network node 210a may provide precoding information indicating which precoder, defined by the codebook, is to be used by the UE 220a. Non-codebook-based precoding may involve selecting or deriving a precoder based on, or otherwise associated with, one or more downlink or uplink signal measurements. The network node 210a or the UE 220a may transmit the processed downlink or uplink signals, respectively, via one or more antennas.

The network node 210a or the UE 220a may receive uplink signals or downlink signals, respectively, via one or more antennas. The network node 210a or the UE 220a (for example, using the processing system 245 or the processing system 240, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 210 or the UE 220 via the downlink or uplink signals. The network node 210a or the UE 220a (for example, using the processing system 245 or the processing system 240, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 220 and a network node 210 may perform MIMO communication. MIMO communication generally refers to transmitting or receiving multiple signals (such as multiple layers or multiple data streams) simultaneously over the same time and frequency resources. A network node 210 or a UE 220 may communicate using single-user MIMO or multi-user MIMO (MU-MIMO), the latter of which being used by a network node 210 to simultaneously transmit signals to multiple UEs 220. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 210 may generate one or more beams 260a, and a UE 220 may generate one or more beams 260b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 210 or a UE 220 may implement massive MIMO, which may be associated with an increased (for example, “massive”) quantity of antennas at the network node 210 or at the UE 220, such as in a network implementing mmWave technology, which enables more precise beamforming or reduced interference. In some examples, the wireless communication network 200 may implement multi-TRP (mTRP) operation (including redundant transmission or reception on multiple TRPs) or non-coherent joint transmission (NC-JT).

The network node 210 and the UE 220 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 210 transmitting signals (for example, SSBs or other signals) via respective beams (for example, of the beams 260 of the network node 210) and the UE 220 receiving and measuring the signal(s) via respective beams of multiple beams (for example, from the beams 260 of the UE 220) to identify a best beam (or beam pair) for communication between the UE 220 and the network node 210. A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 265 (for example, one or more network nodes 210, one or more UEs 220, one or more servers, or one or more components of a cloud computing network, among other examples). For example, in a deployment in which AI/ML functionality is performed independently at a device 265, sometimes referred to as “overlay AI/ML,” the AI/ML model (or an instance or portion of the AI/ML model) may be deployed at a UE 220 (for example, by the processing system 240), a network node 210 (for example, by the processing system 245), one or more servers, or one or more components of a cloud computing network, among other examples. Additionally, or alternatively, in a deployment where AI/ML functionality is coordinated between different devices 265, sometimes referred to as “coordinated AI/ML,” or performed at all device and network layers, sometimes referred to as “native AI/ML,” the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, or efficient use of network bandwidth, or to reduce latency, among other examples). For example, the AI/ML model(s) may be trained to identify patterns or relationships in data corresponding to the wireless communication network 200, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 220, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a network entity (e.g., the UE 220) may include a communication manager 250. As described in more detail elsewhere herein, the communication manager 250 may transmit, during a random access procedure, a first indication of a first SSB index, wherein the first SSB index indicates first spatial direction information for downlink; and transmit, during the random access procedure, a second indication of a second SSB index, wherein the second SSB index indicates second spatial direction information for uplink. Additionally, or alternatively, the communication manager 250 may perform one or more other operations described herein.

In some aspects, a network entity (e.g., the network node 210) may include a communication manager 255. As described in more detail elsewhere herein, the communication manager 255 may receive, during a random access procedure, a first indication of a first SSB index, wherein the first SSB index indicates first spatial direction information for downlink; and receive, during the random access procedure, a second indication of a second SSB index, wherein the second SSB index indicates second spatial direction information for uplink. Additionally, or alternatively, the communication manager 255 may perform one or more other operations described herein.

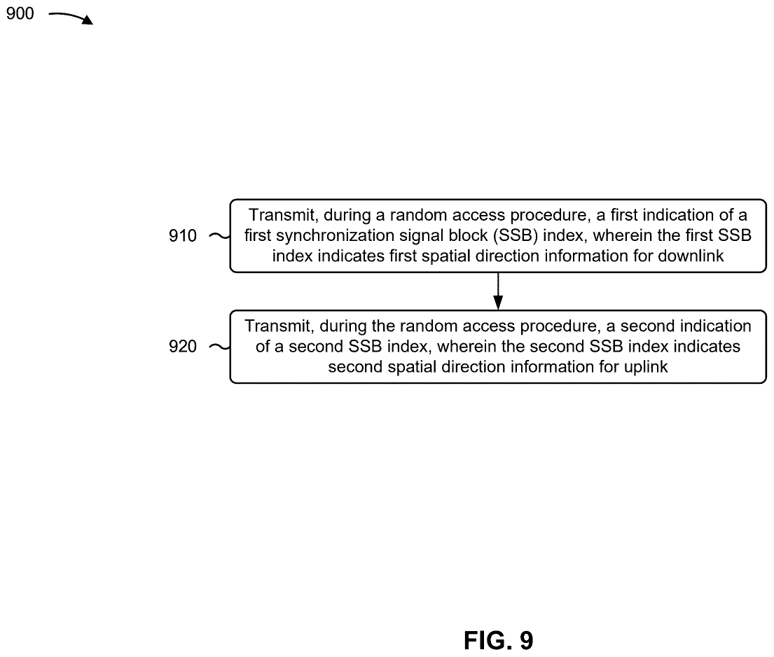

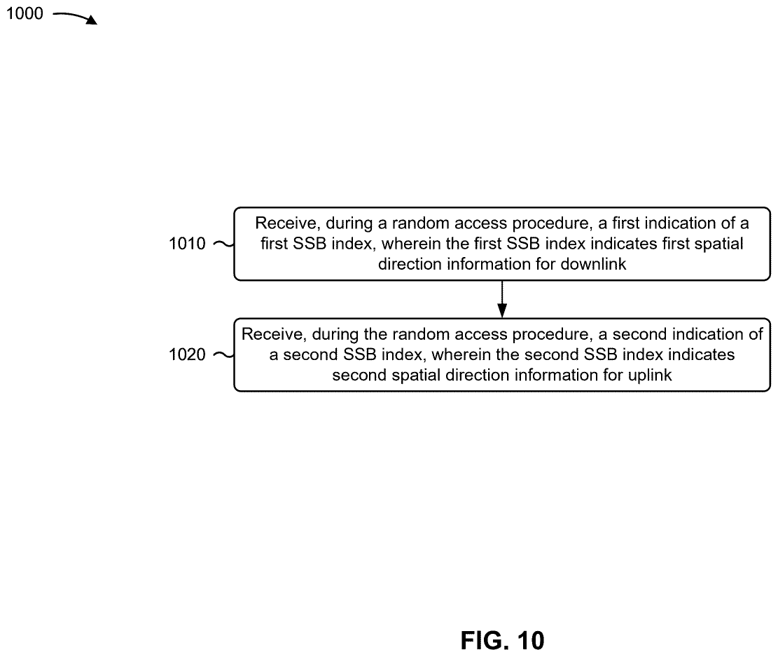

The network entity 102, the processing system 110 of the network entity 102, the network entity 106, the processing system 112 of the network entity 106, the network node 210, the processing system 245 of the network node 210, the UE 220, the processing system 240 of the UE 220, or any other component(s) of FIGS. 1-2 may implement one or more techniques or perform one or more operations associated with uplink and downlink spatial direction indication during random access, as described in more detail elsewhere herein. For example, the processing system 110 of the network entity 102, the processing system 112 of the network entity 106, the processing system 245 of the network node 210, or the processing system 240 of the UE 220 may perform or direct operations of, for example, process 900 of FIG. 9, process 1000 of FIG. 10, or other processes as described herein (alone or in conjunction with one or more other processors). Memory of the network node 210 may store data and program code (or instructions) for the network node 210. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, or the UE 220 may cause the one or more processors to perform process 900 of FIG. 9, process 1000 of FIG. 10, or other processes as described herein. In some examples, executing instructions may include running the instructions, converting the instructions, compiling the instructions, or interpreting the instructions, among other examples.

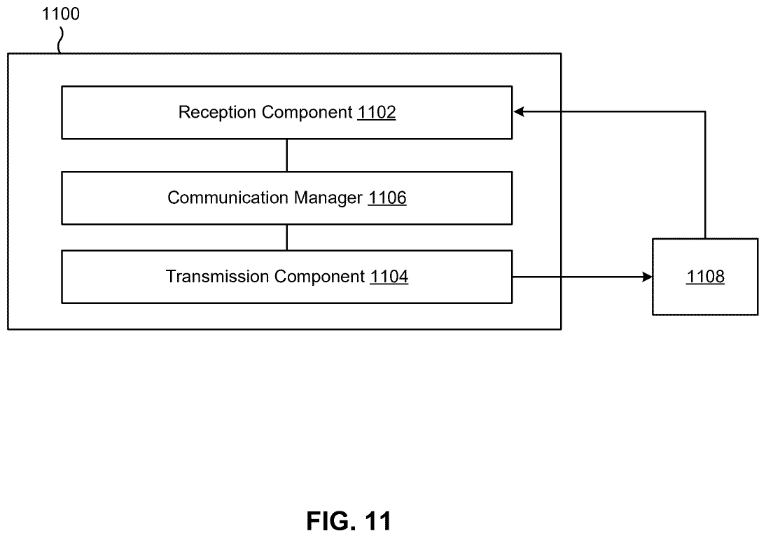

In some aspects, a network entity includes means for transmitting, during a random access procedure, a first indication of a first SSB index, wherein the first SSB index indicates first spatial direction information for downlink; or means for transmitting, during the random access procedure, a second indication of a second SSB index, wherein the second SSB index indicates second spatial direction information for uplink. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1102 depicted and described in connection with FIG. 11) and/or a transmission component (for example, transmission component 1104 depicted and described in connection with FIG. 11), among other examples.

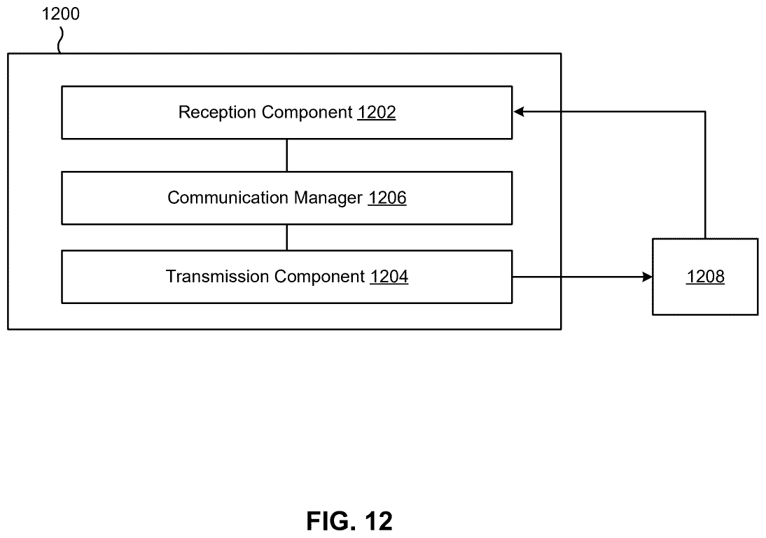

In some aspects, the network entity includes means for receiving, during a random access procedure, a first indication of a first SSB index, wherein the first SSB index indicates first spatial direction information for downlink; or means for receiving, during the random access procedure, a second indication of a second SSB index, wherein the second SSB index indicates second spatial direction information for uplink. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12), among other examples.

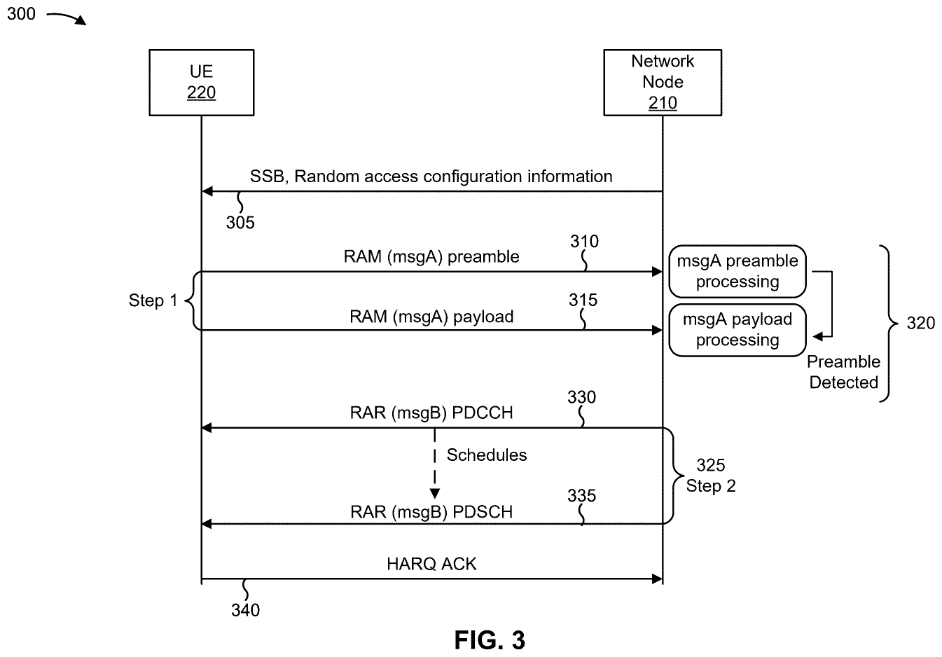

FIG. 3 is a diagram illustrating an example 300 of a two-step random access procedure. As shown in FIG. 3, a network node 210 and a UE 220 may communicate with one another to perform the two-step random access procedure.

As shown by reference number 305, the network node 210 may transmit, and the UE 220 may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the two-step random access procedure, such as one or more parameters for transmitting a random access message (RAM) or receiving a random access response (RAR) to the RAM.

As shown by reference number 310, the UE 220 may transmit, and the network node 210 may receive, a RAM preamble. As shown by reference number 315, the UE 220 may transmit, and the network node 210 may receive, a RAM payload. As shown, the UE 220 may transmit the RAM preamble and the RAM payload to the network node 210 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a physical random access channel (PRACH) preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), or a PUSCH transmission).

As shown by reference number 320, the network node 210 may receive the RAM preamble transmitted by the UE 220. If the network node 210 successfully receives and decodes the RAM preamble, the network node 210 may then receive and decode the RAM payload.

As shown by reference number 325, the network node 210 may transmit an RAR (sometimes referred to as an RAR message). As shown, the network node 210 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, or contention resolution information.

As shown by reference number 330, as part of the second step of the two-step random access procedure, the network node 210 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 335, as part of the second step of the two-step random access procedure, the network node 210 may transmit the PDSCH communication for the RAR, as scheduled by the PDCCH communication. The RAR may be included in a MAC protocol data unit (PDU) of the PDSCH communication. As shown by reference number 340, if the UE 220 successfully receives the RAR, the UE 220 may transmit a hybrid automatic repeat request (HARQ) acknowledgement (ACK).

As indicated above, FIG. 3 is provided as an example. Other examples may differ from what is described with regard to FIG. 3.

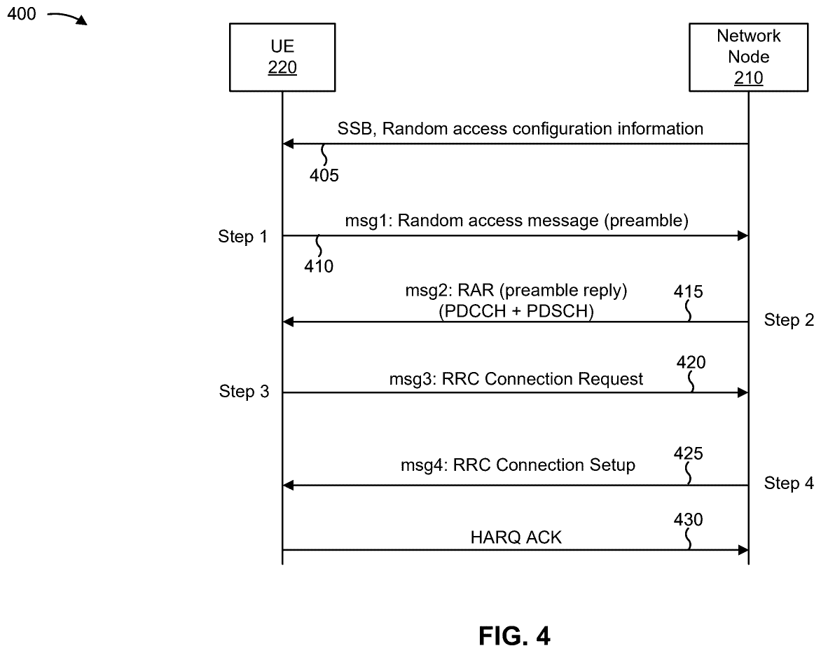

FIG. 4 is a diagram illustrating an example 400 of a four-step random access procedure. As shown in FIG. 4, a network node 210 and a UE 220 may communicate with one another to perform the four-step random access procedure.

As shown by reference number 405, the network node 210 may transmit, and the UE 220 may receive, one or more SSBs and random access configuration information. In some aspects, the random access configuration information may be transmitted in or indicated by system information (e.g., in one or more SIBs) or an SSB, such as for contention-based random access. Additionally, or alternatively, the random access configuration information may be transmitted in a RRC message or a PDCCH order message that triggers a RACH procedure, such as for contention-free random access. The random access configuration information may include one or more parameters to be used in the random access procedure, such as one or more parameters for transmitting a RAM or one or more parameters for receiving an RAR.

As shown by reference number 410, the UE 220 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 210 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 220 in msg1). Additionally, or alternatively, the RAR may indicate a resource allocation to be used by the UE 220 to transmit message 4 (msg3).

In some aspects, as part of the second step of the four-step random access procedure, the network node 210 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 210 may transmit the PDSCH communication for the RAR, as scheduled by the PDCCH communication. The RAR may be included in a MAC protocol data unit (PDU) of the PDSCH communication.

As shown by reference number 420, the UE 220 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 425, the network node 210 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 430, if the UE 220 successfully receives the RRC connection setup message, the UE 220 may transmit a HARQ ACK. In some examples, the HARQ ACK message as message 5, msg5, MSG5, or a fifth message.

As indicated above, FIG. 4 is provided as an example. Other examples may differ from what is described with regard to FIG. 4.

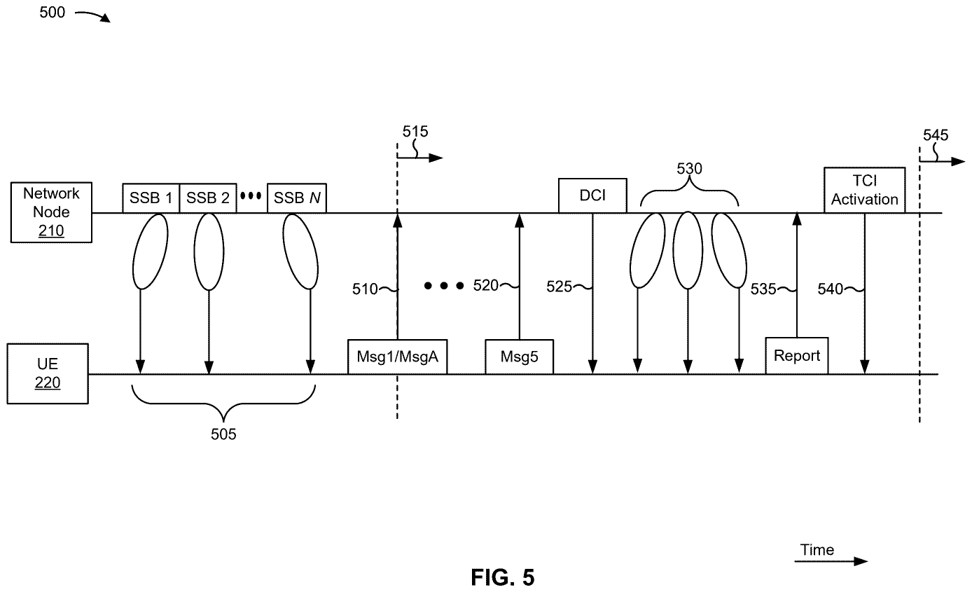

FIG. 5 is a diagram illustrating an example 500 of uplink and downlink beam indications.

As shown in FIG. 5, and by reference number 505, a network node 210 may transmit, and a UE 220 may receive, one or more SSBs (shown as SSB 1 through SSB N). The network node 210 may transmit each of the one or more SSBs in a respective spatial direction. For example, the network node 210 may transmit the one or more SSBs using different transmit beams. The beams used to transmit the SSB(s) may be wide beams. The UE 220 may receive, decode, measure, or otherwise process the one or more SSBs.

As shown by reference number 510, the UE 220 may transmit a random access message (such as a RAM preamble of an msgA or a msg1) to initiate a random access procedure (e.g., as described in more detail in connection with FIGS. 3 and 4). The random access message may be transmitted via an RO. The RO may include one or more time domain resources and one or more frequency domain resources. The RO may be associated with (for example, mapped to) an SSB index. The SSB index may correspond to an SSB from the one or more SSBs. The SSB may be an SSB with a highest measurement value as measured by the UE 220. By the UE 220 transmitting the random access message using the RO that is mapped to the SSB index, the network node 210 may identify that the spatial direction information (e.g., the beam) used to transmit the SSB is the best downlink spatial direction information (e.g., the downlink beam) for the UE 220. However, this may increase latency associated with initiating the random access procedure, because the UE 220 may wait until a next RO that is mapped to the SSB index (e.g., refraining from transmitting during ROs mapped to other SSB indices which may occur earlier in time).

Therefore, starting at a time 515, the UE 220 and the network node 210 may communicate using the downlink spatial direction information for one or more downlink messages. The UE 220 and the network node 210 may perform the random access procedure (e.g., in a similar manner as described in connection with FIGS. 3 and 4). As shown by reference number 520 the UE 220 may transmit, and the network node 210 may receive, a msg5 (e.g., a HARQ ACK) that indicates that an RRC connection was successfully established as part of the random access procedure.

As shown by reference number 525, the network node 210 may transmit, and the UE 220 may receive, downlink control information triggering a wide beam sweep (e.g., a P1 beam management procedure) for the UE 220. As shown by reference number 530, the network node 210 may transmit, and the UE 220 may receive, one or more reference signals (such as SSBs or CSI-RSs). The network node 210 may transmit each of the one or more reference signals in a respective spatial direction. For example, the network node 210 may transmit the one or more reference signals using different transmit beams. The beams used to transmit the reference signal(s) may be wide beams. The UE 220 may receive, decode, measure, or otherwise process the one or more reference signals.

As shown by reference number 535, the UE 220 may transmit, and the network node 210 may receive, a report. The report may be a beam report (e.g., an aperiodic beam report), a measurement report, or another type of report. The report may indicate measurement values for respective reference signal indices (e.g., corresponding to the one or more reference signals). In some examples, the report may indicate a reference signal index that is associated with a highest measurement value. The network node 210 may determine spatial direction information for uplink (e.g., using uplink-to-downlink reciprocity) based on the information included in the report. As shown by reference number 540, the network node 210 may transmit, and the UE 220 may receive, a TCI state activation message (e.g., via one or more MAC-CEs). The TCI state activation may activate a TCI state corresponding to the spatial direction information for uplink. Therefore, at a time 545 (e.g., after a delay from the transmission of the TCI state activation message), the UE 220 and the network node 210 may communicate using the uplink spatial direction information (e.g., the TCI state) for one or more uplink messages.

As shown in FIG. 5, a delay may be introduced between the time 515 (e.g., at which the downlink spatial direction information can be used) and the time 545 (e.g., at which the uplink spatial direction information can be used). Therefore, any uplink messages transmitted between the time 515 and the time 545 may experience degraded or sub-optimal performance. Additionally, this process consumes network resources, processing resources, or energy resources, among other examples, associated with performing one or more beam management operations to determine the uplink spatial direction information.

As indicated above, FIG. 5 is provided as an example. Other examples may differ from what is described with regard to FIG. 5.

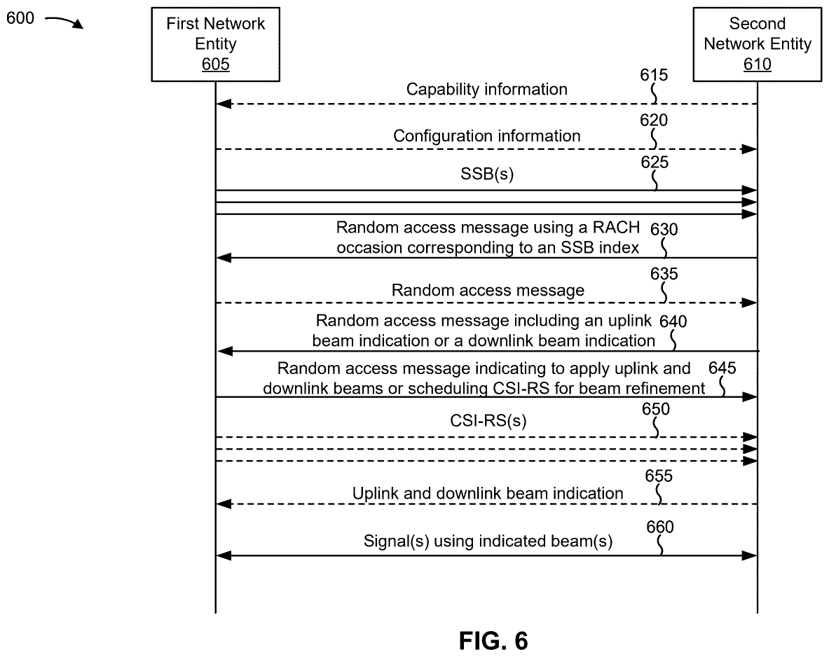

FIG. 6 is a diagram of an example 600 associated with uplink and downlink spatial direction indication during random access. As shown in FIG. 6, a first network entity 605 (e.g., a network node 210, the network entity 102, or the network entity 106) may communicate with a second network entity 610 (e.g., a UE 220, the network entity 102, or the network entity 106). In some aspects, the first network entity 605 and the second network entity 610 may be part of a wireless network (e.g., the wireless communication network 108). The second network entity 610 and the first network entity 605 may communicate using beamformed signals.

In some aspects, as shown by reference number 615, the second network entity 610 may transmit capability information. The capability information may be included in a capability report. The second network entity 610 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the second network entity 610. The one or more parameters may be indicated via respective information elements (IEs) included in the capability report.

The capability information may indicate whether the second network entity 610 supports a feature or one or more parameters related to the feature. For example, the capability information may indicate a capability or parameter for supporting separate uplink and downlink beam indications during a random access procedure (e.g., during initial access). As another example, the capability information may indicate a capability or parameter indicating support for indicating an uplink beam indication (e.g., an SSB index corresponding to an SSB) in a random access message, such as a msgA or a msg3. One or more operations described herein may be based on capability information. For example, the second network entity 610 may perform a communication in accordance with the capability information, or may receive configuration information that is in accordance with the capability information. In some aspects, the capability information may indicate support for a narrow beam refinement operation (e.g., being configured with CSI-RS sets for beam refinement) during a random access procedure. “CSI-RS set” may be used interchangeably with “CSI-RS resource set.”

As shown by reference number 620, the first network entity 605 may transmit, and the second network entity 610 may receive, configuration information. In some aspects, the second network entity 610 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the second network entity 610 or previously indicated by the network node or other network device), or explicit configuration information for the second network entity 610 to use to configure the second network entity 610, among other examples.

In some examples, the configuration information may not be expressly signaled to the second network entity 610. For example, in some aspects, the configuration information may at least partially be defined by a wireless communication standard, such as the 3GPP. In such examples, the first network entity 605 may not explicitly indicate such configuration information to the second network entity 610. For example, the second network entity 610 may optionally obtain at least a portion of the configuration information from a configuration stored by the second network entity 610 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the second network entity 610 is to transmit separate uplink and downlink beam indications during a random access procedure. For example, the configuration information may include random access configuration information. The random access configuration information may be included in a RachConfig IE or a similar IE.

The second network entity 610 may configure itself based at least in part on the configuration information. In some aspects, the second network entity 610 may be configured to perform one or more operations described herein based at least in part on the configuration information.

As shown by reference number 625, the first network entity 605 may transmit, and the second network entity 610 may receive, one or more SSBs. For example, a synchronization signal (SS) hierarchy may include an SS burst set, which may include multiple SS bursts. Each SS burst may include one or more SSBs. In some aspects, different SSBs may be beam-formed differently (e.g., transmitted using different beams), and may be used for cell search, cell acquisition, beam management, or beam selection (e.g., as part of an initial network access procedure). An SS burst set may be periodically transmitted by the first network entity 605, such as every X milliseconds. In some aspects, an SS burst set may have a fixed or dynamic length, such as Y milliseconds. In some cases, an SS burst set or an SS burst may be referred to as a discovery reference signal (DRS) transmission window or an SSB measurement time configuration (SMTC) window.

An SSB may include resources that carry a primary synchronization signal (PSS), a secondary synchronization signal (SSS), or a physical broadcast channel (PBCH). In some aspects, multiple SSBs are included in an SS burst (e.g., with transmission on different beams), and the PSS, the SSS, or the PBCH may be the same across each SSB of the SS burst. In some aspects, a single SSB may be included in an SS burst. In some aspects, the SSB may be at least four symbols (e.g., OFDM symbols) in length, where each symbol carries one or more of the PSS (e.g., occupying one symbol), the SSS (e.g., occupying one symbol), or the PBCH (e.g., occupying two symbols). In some aspects, an SSB may be referred to as an SS/PBCH block.

In some aspects, an SSB may include, or be mapped to, an SSB index, which may correspond to a beam used to carry the SSB. The second network entity 610 may monitor for or measure SSBs using different receive (Rx) beams during an initial access procedure (e.g., a random access procedure), among other examples. Based at least in part on the monitoring or measuring, the second network entity 610 may determine one or more SSBs with a best signal parameter (e.g., an RSRP parameter). For example, the second network entity 610 may measure the one or more SSBs to obtain measurement information. The measurement information may indicate a signal parameter (e.g., a measurement value) for respective SSBs of the one or more SSBs. The measurement information may be downlink measurement information.

As shown by reference number 630, the second network entity may transmit, and the first network entity 605 may receive, a first indication of a first SSB index. The first SSB index may indicate first spatial direction information (e.g., a first beam) for downlink. For example, the first spatial direction information may be a downlink beam indication. For example, the first network entity 605 and the second network entity 610 may use an indicated SSB to select a downlink beam to be used for communication between the first network entity 605 and the second network entity 610 (e.g., for a random access procedure). Additionally, or alternatively, the second network entity 610 may use the SSB or the SSB index to determine a cell timing for a cell via which the SSB is received (e.g., a serving cell).

For example, the second network entity may transmit, and the first network entity 605 may receive, a first random access message during an RO that is associated with the first SSB index. The first random access message may be an msg1 of a four-step random access procedure (e.g., as depicted and described in connection with reference number 410 and FIG. 4). In some other examples, the first random access message may be a RAM preamble of an msgA of a two-step random access procedure (e.g., as depicted and described in connection with reference number 310 and FIG. 3).

In some examples, the SSB (e.g., having an SSB index mapped to the RO used to transmit the first random access message) may be associated with a highest measurement value (e.g., among the SSBs measured by the second network entity 610). In such examples, the first spatial direction information (e.g., downlink spatial direction information or a downlink beam) indicated by the first random access message may indicate a best, or optimal, downlink beam for the second network entity 610.

In other examples, the SSB may be associated with a measurement value that satisfies a threshold. The threshold may be indicated by the configuration information. For example, the SSB may be associated with a measurement value that satisfies the threshold and mapped to an earliest RO in time (e.g., among ROs mapped to SSBs that have measurement values satisfying the threshold). For example, the SSB may not have the highest measurement value among SSBs measured by the second network entity 610 (e.g., the downlink beam indicated by the SSB index may be sub-optimal beam). However, because the SSB may be associated with a measurement value that satisfies the threshold, the downlink beam indicated by the SSB index may result in a sufficient performance level for the random access procedure (e.g., until the second network entity 610 indicates an SSB index of the SSB associated with the highest measurement value). Additionally, because the SSB may be mapped to an earliest RO in time among ROs mapped to SSBs that have measurement values satisfying the threshold, latency associated with transmitting the first random access message may be reduced.

In some aspects, as shown by reference number 635, the first network entity 605 may transmit, and the second network entity 610 may receive, a random access message (e.g., a second random access message). The second random access message may be an msg2 of a four-step random access procedure (e.g., as depicted and described in connection with reference number 415 and FIG. 4). The first network entity 605 may transmit the second random access message using the first spatial direction information (e.g., indicated by the SSB index mapped to the RO used to transmit the random access message as described in connection with reference number 630). For example, the first network entity 605 may perform beamforming to transmit the random access message (e.g., the msg2) in a direction indicated by the first spatial direction. For example, the first network entity 605 may apply one or more beamforming parameters used to transmit the SSB (e.g., mapped to the SSB index indicated by the second network entity 610) to transmit the random access message (e.g., the msg2). The first network entity 605 may apply one or more beamforming parameters to an antenna array to focus a transmission beam in the spatial direction, enhancing signal strength and quality, or reducing interference, among other examples. This improves the likelihood that the communication link for the random access message (e.g., the msg2) is robust and efficient, leveraging a sufficient (or best possible) beam direction for the transmission.

As shown by reference number 640, the second network entity 610 may transmit, and the first network entity 605 may receive, a second indication of a second SSB index (e.g., during the random access procedure). For example, the second network entity 610 may transmit, and the first network entity 605 may receive, a random access message that includes the second indication of the second SSB index. The random access message may be an msg3 of a four-step random access procedure (e.g., as depicted and described in connection with reference number 420 and FIG. 4). In other examples, the random access message may be a RAM payload of an msgA of a two-step random access procedure (e.g., as depicted and described in connection with reference number 315 and FIG. 3).

The second SSB index may indicate uplink spatial direction information (e.g., the second indication of the second SSB index may be an uplink beam indication). In some examples, the first SSB index (e.g., indicated as a downlink beam indication) and the second SSB index (e.g., indicated as the uplink beam indication) may be the same SSB index. In other examples, the first SSB index and the second SSB index may be different.

For example, the second network entity 610 may determine the second SSB index based on the measurement information obtained from measuring the one or more SSBs (e.g., transmitted by the first network entity 605 as described in connection with reference number 625). The second network entity 610 may determine an SSB index corresponding to an SSB associated with a highest measurement value (or best performance) for uplink. For example, in TDD systems, there may be an assumption of channel reciprocity, meaning the channel characteristics for the downlink and the uplink are similar. This assumption allows the second network entity 610 to infer the quality of the uplink channel based on the measurements of the downlink SSBs. The second network entity 610 may also consider factors, such as interference levels and physical obstructions that could affect the uplink transmissions, when determining the SSB index to indicate for uplink (e.g., for an uplink beam indication). For example, the second network entity 610 may consider MPE restrictions when determining the SSB index to indicate for uplink (e.g., if a highest measured SSB index corresponding to a highest measured SSB is associated with a spatial direction that is blocked by a human body, then the second network entity 610 may select an SSB index associated with a next highest measured SSB that is associated with a spatial direction that is not blocked by a human body). For example, if the second network entity 610 detects that a particular SSB has a high-quality downlink channel but is obstructed or has high interference in the uplink path (e.g., due to a human body or other physical barriers), the second network entity 610 may choose a different SSB that provides a more reliable uplink path.

In some examples, the random access message that includes the second indication of the second SSB index may include a third SSB index. The third SSB index may indicate third spatial direction information for downlink. For example, the third SSB index may indicate a downlink beam indication. For example, as described above, the RO used to transmit an initial message (e.g., as depicted by reference number 630) in the random access procedure may be mapped to an SSB index that indicates sub-optimal spatial direction information (e.g., a sub-optimal downlink beam) to reduce latency associated with transmitting the initial message. In such examples, the random access message (e.g., the msg3 or the RAM payload of the msgA) may include a downlink beam indication corresponding to an SSB having a highest measurement value among the SSBs measured by the second network entity 610.

The first network entity 605 may receive the second SSB index that indicates the second spatial direction information (e.g., the uplink beam indication) and may determine an uplink beam (e.g., a best uplink beam) to be used by the second network entity 610 based on the second spatial direction information. The uplink beam may be configured by a TCI state. The TCI state may be a configuration that includes beamforming parameters, such as the angle of departure (AoD) or the beamforming weights to steer the beam in the optimal direction for uplink transmission. By configuring the TCI state for uplink, the first network entity 605 may improve the likelihood that uplink transmissions are aligned with an optimal path, thereby improving performance for the uplink transmissions by improving signal quality or reducing interference, among other examples.

Additionally, the first network entity 605 may determine a downlink beam (e.g., a best downlink beam) to be used by the first network entity 605 for transmitting downlink messages to the second network entity 610. The first network entity 605 may determine the downlink beam based on the first spatial direction information (e.g., indicated by beamforming parameters of the SSB associated with the SSB index mapped to the RO used by the second network entity 610 to transmit the initial message in the random access procedure). In some other examples, the first network entity 605 may determine the downlink beam based on third spatial direction information for downlink (e.g., included in the random access message (msg3) depicted and described in connection with reference number 640).

For example, the first network entity 605 may determine an uplink and downlink beam pair for communication with the second network entity 610. The uplink and downlink beam pair may be indicated by one or more TCI states, such as separate uplink TCI states and downlink TCI states, or joint uplink and downlink TCI states, among other examples.

As shown by reference number 645, the first network entity 605 may transmit, and the second network entity 610 may receive, a random access message indicating that the second network entity 610 is to apply the second spatial direction information for uplink. In some aspects, the random access message may indicate that the second network entity 610 is to apply the third spatial direction information for downlink. The random access message may be an msg4 of a four-step random access procedure (e.g., as depicted and described in connection with reference number 425 and FIG. 4). In some other examples, the random access message may be an msgB of a two-step random access procedure (e.g., as depicted and described in connection with reference number 335 and FIG. 3). As a result, the second network entity 610 may be configured to apply a best uplink beam and a best downlink beam during the random access procedure, thereby reducing latency and conserving resources that would have otherwise been associated with determining and configuring the second network entity 610 to apply the best uplink beam and the best downlink beam.

In some aspects, the random access message (e.g., depicted and described in connection with reference number 645, such as the msg4 or the msgB) may configure one or more CSI-RS resource sets for beam refinement. In some examples, the first network entity 605 may transmit, and the second network entity 610 may receive, configuration information (e.g., a CSI-RS resource set configuration) associated with a first CSI-RS set and a second CSI-RS set. The first CSI-RS set is based on the first spatial direction information or the third spatial direction information (e.g., the best downlink spatial direction information or the best downlink wide beam as indicated by the second network entity 610). For example, the CSI-RS resources configured in the first CSI-RS set may be associated with narrow beams that are within (or are close to) an angular span of the downlink wide beam as indicated by the second network entity 610. The second CSI-RS set is based on the second spatial direction information (e.g., the best uplink spatial direction information or the best uplink wide beam as indicated by the second network entity 610). For example, the CSI-RS resources configured in the second CSI-RS set may be associated with narrow beams that are within (or are close to) an angular span of the uplink wide beam as indicated by the second network entity 610.

In some examples, the configuration information may include a single CSI-RS set. For example, the single CSI-RS set may be based on the best downlink spatial direction information or the best downlink wide beam as indicated by the second network entity 610. In such examples, the second network entity 610 may refine both an uplink beam and a downlink beam from CSI-RS resources included in a single CSI-RS set. This may reduce configuration and signaling overhead for the beam refinement.

As shown by reference number 650, the first network entity 605 may transmit, and the second network entity 610 may receive, one or more CSI-RSs (e.g., as configured by the CSI-RS resource set configuration. For example, the first network entity 605 and the second network entity 610 may perform beam management using CSI-RSs (e.g., during the random access procedure) based on the wide beam(s) indicated via SSB indices. For example, the first network entity 605 and the second network entity 610 may perform a second beam management procedure (e.g., P2 CSI-RS beam management). The second beam management procedure may be referred to as a beam refinement procedure, a network node beam refinement procedure, a TRP beam refinement procedure, downlink beam refinement, or a transmit beam refinement procedure. The CSI-RSs may be configured to be transmitted from the first network entity 605 to the second network entity 610. The CSI-RSs may be configured to be aperiodic (e.g., using control information included in the random access message, such as the msg4 or the msgB). The second beam management procedure may include the first network entity 605 performing beam sweeping over one or more transmit beams (e.g., that are narrow beams included within an angular span of a wide beam indicated by the SSB index that was indicated as the best downlink beam). The one or more transmit beams may be a subset of all transmit beams associated with the first network entity 605 (e.g., determined based at least in part on the SSB index indicated by the second network entity 610 in the msg1, the msg3, or the msgA of the random access procedure). The first network entity 605 may transmit a CSI-RS using each transmit beam of the one or more transmit beams for beam management. The second network entity 610 may measure each CSI-RS using a single (e.g., a same) receive beam (e.g., determined based on the wide beam corresponding to the SSB index indicated as being associated with the best uplink beam as depicted and described in connection with reference number 640). The second beam management procedure may enable the first network entity 605 to select a best transmit beam (e.g., a best narrow beam for downlink) based on measurements of the CSI-RSs (e.g., measured by the second network entity 610 using the single receive beam) reported by the second network entity 610.

Additionally, or alternatively, the first network entity 605 and the second network entity 610 may perform a third beam management procedure (e.g., P3 CSI-RS beam management). The third beam management procedure may be referred to as a beam refinement procedure, a UE beam refinement procedure, uplink beam refinement, or a receive beam refinement procedure. For example, one or more CSI-RSs may be configured to be transmitted from the first network entity 605 to the second network entity 610. The CSI-RSs may be configured to be aperiodic. The third beam management process may include the first network entity 605 transmitting the one or more CSI-RSs using a single transmit beam (e.g., determined based at least in part on measurements reported by the second network entity 610 in connection with the first beam management procedure or the second beam management procedure). To enable the second network entity 610 to perform receive beam sweeping, the network node may use a downlink beam to transmit (e.g., with repetitions) CSI-RS at multiple times within the same CSI-RS set so that the second network entity 610 can sweep through one or more uplink beams in multiple transmission instances. The one or more receive beams may be a subset of all receive beams associated with the second network entity 610 (e.g., determined based at least in part on measurements performed in connection with the first beam management procedure or the second beam management procedure). The third beam management procedure may enable the first network entity 605 or the second network entity 610 to select a best narrow uplink beam based on reported measurements received from the second network entity 610 (e.g., of the CSI-RS of the downlink beam using the one or more uplink beams).

As shown by reference number 655, the second network entity 610 may transmit, and the first network entity 605 may receive, an uplink beam indication and a downlink beam indication. The uplink beam indication and the downlink beam indication may be narrow beam indications. For example, the second network entity 610 may transmit, and the first network entity 605 may receive, an indication of one or more first CSI-RS indices from the first CSI-RS set. The one or more first CSI-RS indices may indicate spatial direction information for the downlink (e.g., that indicate a narrow beam for downlink). For example, the second network entity 610 may measure one or more first CSI-RSs, from the first CSI-RS set, to obtain first measurement information (e.g., during the second beam management procedure). The second network entity 610 may determine or select the one or more first CSI-RS indices based on the first measurement information (e.g., the first measurement information may indicate that the one or more first CSI-RS indices correspond to highest measurement values obtained during the second beam management procedure). For example, the first spatial direction information (or the third spatial direction information) may indicate a first beam for the downlink (e.g., a wide beam that is indicated by an SSB index). The spatial direction information indicated by the one or more first CSI-RS indices may indicate a second beam for the downlink (e.g., a narrow beam). For example, the second beam may be refined from the first beam.

Additionally, or alternatively, the second network entity 610 may transmit, and the first network entity 605 may receive, an indication of one or more second CSI-RS indices from the second CSI-RS set (or the first CSI-RS set). The one or more second CSI-RS indices may indicate spatial direction information for the uplink. For example, the second network entity 610 may measure one or more second CSI-RSs, from the second CSI-RS set, to obtain second measurement information (e.g., during the third beam management procedure). The second network entity 610 may determine or select the one or more second CSI-RS indices based on the second measurement information (e.g., the second measurement information may indicate that the one or more second CSI-RS indices correspond to highest measurement values obtained during the third beam management procedure). For example, the second spatial direction information may indicate a first beam for the uplink (e.g., a wide beam that is indicated by an SSB index). The spatial direction information indicated by the one or more second CSI-RS indices may indicate a second beam for the uplink (e.g., a narrow beam). For example, the second beam may be refined from the first beam. In some examples, the indication of the one or more first CSI-RS indices and the indication of the one or more second CSI-RS indices may be included in a random access message associated with the random access procedure. The narrow beam indications may improve performance for uplink and downlink transmissions. For example, narrow beams may be associated with higher beamforming gain (e.g., as compared to wide beams indicated by SSB indices), resulting in improved performance for the uplink and downlink transmissions. By the second network entity 610 indicating the narrow beam indications during the random access procedure, latency or a delay associated with the first network entity 605 and the second network entity 610 communicating using the narrow beams may be reduced.

In some aspects, the second network entity 610 may indicate an uplink beam indicated as part of a fallback operation (e.g., a fallback operation from a two-step random access procedure to a four-step random access procedure). For example, as described in connection with reference number 640, the second network entity 610 may include an uplink beam indication (e.g., an SSB index for uplink) in a RAM payload of an msgA in a two-step random access procedure. In some examples, the first network entity 605 may fail to decode the RAM payload of an msgA. In such examples, the first network entity 605 may transmit, and the second network entity 610 may receive, an indication to fall back to a four-step random access procedure. In such examples, the second network entity 610 may transmit, and the first network entity 605 may receive, during the four-step random access procedure, a random access message that includes the second indication of the second SSB index (e.g., the SSB index indicated in the RAM payload that was not decoded successfully by the first network entity 605). For example, the second network entity 610 may re-indicate the second SSB index (e.g., to indicate the uplink beam indication) in an msg3 of the four-step random access procedure. This enables the first network entity 605 to obtain the uplink beam indication as part of the fallback operation.

As shown by reference number 660, the first network entity 605 and the second network entity 610 may communicate, based on the uplink spatial direction information or the downlink spatial direction information, one or more signals. The uplink spatial direction information may indicate the uplink beam (e.g., the wide beam indicated by the second SSB index or the narrow beam indicated by the one or more second CSI-RS indices). The downlink spatial direction information may indicate the downlink beam (e.g., the wide beam indicated by the first SSB index, the third SSB index, or the narrow beam indicated by the one or more first CSI-RS indices). For example, the first network entity 605 may transmit, and the second network entity 610 may receive, a signal, of the one or more signals, based on the downlink spatial direction information (e.g., using the downlink beam). The second network entity 610 may transmit, and the first network entity may receive, a signal, of the one or more signals, based on the uplink spatial direction information (e.g., using the uplink beam).

As indicated above, FIG. 6 is provided as an example. Other examples may differ from what is described with respect to FIG. 6.

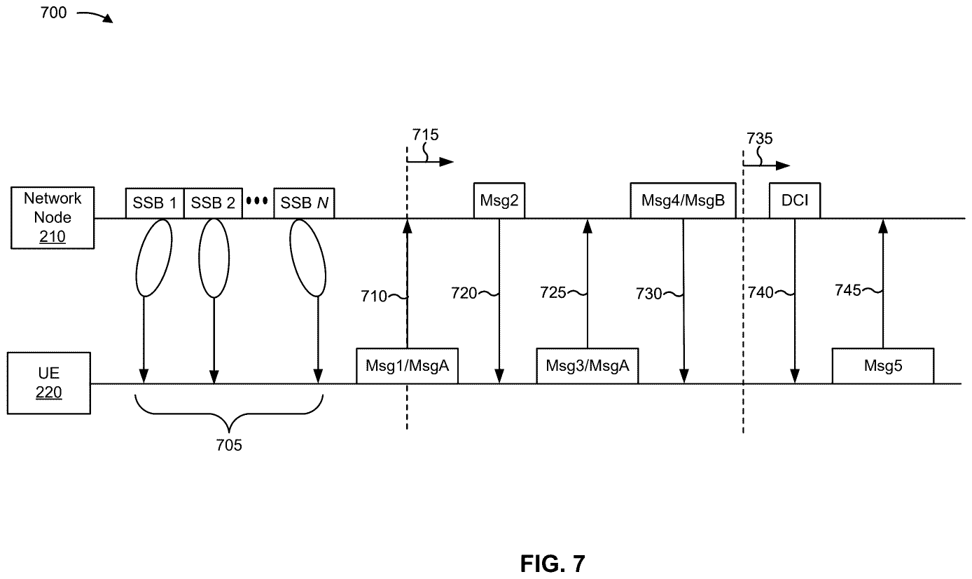

FIG. 7 is a diagram illustrating an example 700 of uplink and downlink beam indications during a random access procedure. The network node 210 depicted and described in connection with FIG. 7 may be an example of the first network entity 605. The UE 220 depicted and described in connection with FIG. 7 may be an example of the second network entity 610.

As shown in FIG. 7, and by reference number 705, a network node 210 may transmit, and a UE 220 may receive, one or more SSBs (shown as SSB 1 through SSB N). The network node 210 may transmit each of the one or more SSBs in a respective spatial direction. For example, the network node 210 may transmit the one or more SSBs using different transmit beams. The beams used to transmit the SSB(s) may be wide beams. The UE 220 may receive, decode, measure, or otherwise process the one or more SSBs. The one or more SSBs may be transmitted in a similar manner as described in connection with reference number 625.

As shown by reference number 710, the UE 220 may transmit a random access message (such as a RAM preamble of an msgA or a msg1) to initiate a random access procedure (e.g., as described in more detail in connection with FIGS. 3 and 4). The random access message may be transmitted via an RO. The RO may include one or more time domain resources and one or more frequency domain resources. The RO may be associated with (for example, mapped to) an SSB index. The SSB index may correspond to an SSB from the one or more SSBs. The SSB may be an SSB with a highest measurement value as measured by the UE 220. By the UE 220 transmitting the random access message using the RO that is mapped to the SSB index, the network node 210 may identify that the spatial direction information (e.g., the beam) used to transmit the SSB is the best downlink spatial direction information (e.g., the downlink beam) for the UE 220. In other examples, the SSB index may be associated with an SSB that does not have the highest measurement value. In such examples, the SSB may have a measurement value that satisfies a threshold and is mapped to an RO that occurs earlier in time than an RO mapped to the SSB having the highest measurement value. This reduces latency associated with initiating the random access procedure.

Therefore, in some aspects, starting at a time 715, the UE 220 and the network node 210 may communicate using the downlink spatial direction information for one or more downlink messages. In some examples, the downlink spatial direction information (e.g., a downlink beam) may be associated with a best downlink beam for the UE 220. In other examples, the downlink spatial direction information (e.g., a downlink beam) may be downlink spatial direction information (e.g., a downlink beam) that may be associated with a sub-optimal (e.g., but sufficient) downlink beam for the UE 220. The UE 220 may indicate the SSB index in a similar manner as described in connection with reference number 630.

As shown by reference number 720, the network node 210 may transmit, and the UE 220 may receive, an msg2 (e.g., during a four-step random access procedure). The network node 210 may transmit the msg2 using the downlink spatial direction information indicated by the msg1 (e.g., transmitted by the UE 220 as described in connection with reference number 710).

As shown by reference number 725, the UE 220 may transmit, and the network node 210 may receive, a random access message (e.g., an msg3 of a four-step random access procedure or an msgA payload of a two-step random access procedure). The random access message may include an uplink beam indication. For example, the random access message may include an SSB index corresponding to an SSB having a best performance for uplink. In some aspects, the random access message may include a downlink beam indication, such as when the RO used for the msg1 or the msgA preamble is mapped to an SSB associated with sub-optimal performance for downlink).

As shown by reference number 730, the network node 210 may transmit, and the UE 220 may receive, an msg4 or an msgB. The msg4 or the msgB may include an indication that the UE 220 is to apply the downlink beam (e.g., indicated as described in connection with reference number 710 or reference number 725) and the uplink beam (e.g., indicated as described in connection with reference number 725). Therefore, starting at a time 735 (e.g., which may occur while the random access procedure is ongoing), the UE 220 and the network node 210 may communicate using optimal uplink and downlink beams.

As shown by reference number 740, the network node 210 may transmit, and the UE 220 may receive, DCI. The DCI may be transmitted using the downlink beam. The DCI may include a timing advance value, or contention resolution information. As shown by reference number 745, if the UE 220 successfully receives the DCI, the UE 220 may transmit a HARQ ACK, such as an msg5. The UE 220 may transmit the msg5 using the uplink beam (e.g., indicated as described in connection with reference number 725).

As indicated above, FIG. 7 is provided as an example. Other examples may differ from what is described with respect to FIG. 7.

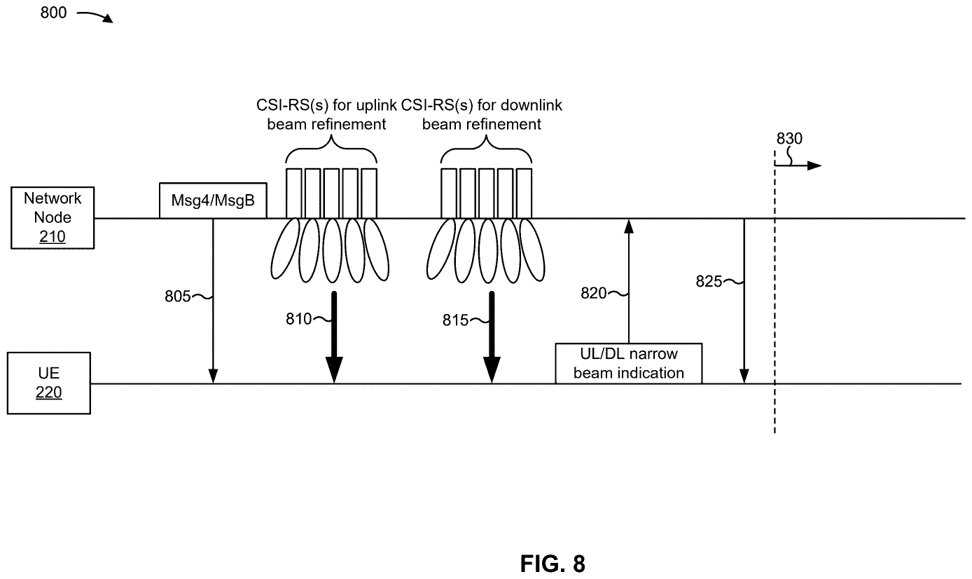

FIG. 8 is a diagram illustrating an example 800 of uplink and downlink beam refinement during a random access procedure. The network node 210 depicted and described in connection with FIG. 8 may be an example of the first network entity 605. The UE 220 depicted and described in connection with FIG. 8 may be an example of the second network entity 610.

As shown by reference number 805, the network node 210 may transmit, and the UE 220 may receive, a random access message (e.g., an msg4 of a four-step random access procedure or an msgB of a two-step random access procedure). The random access message may be similar to the random access message depicted and described in connection with reference number 730. In some examples, the random access message may include configuration information for one or more CSI-RS sets for beam refinement (e.g., in a similar manner as described in connection with reference number 645). For example, a first CSI-RS set may include CSI-RSs configured for beam refinement of a wide beam for downlink indicated by a first SSB index (e.g., such as mapped to an RO used for the random access message depicted and described in connection with reference number 710 or reference number 725). A second CSI-RS set may include CSI-RSs configured for beam refinement of a wide beam for uplink indicated by a second SSB index (e.g., such as depicted and described in connection with reference number 725). In other examples, a single CSI-RS set may be configured for both uplink and downlink beam refinement. The single CSI-RS set may include CSI-RSs configured for beam refinement of a wide beam for downlink indicated by the first SSB index.

As shown by reference number 810, the network node 210 may transmit, and the UE 220 may receive, one or more CSI-RSs for uplink beam refinement (e.g., in a similar manner as described in connection with reference number 650). As shown by reference number 815, the network node 210 may transmit, and the UE 220 may receive, one or more CSI-RSs for downlink beam refinement (e.g., in a similar manner as described in connection with reference number 650). The UE 220 may determine one or more CSI-RS indices for indicating a downlink beam (e.g., a narrow beam for downlink) based on measurement information of the one or more CSI-RSs for downlink beam refinement. The UE 220 may determine one or more CSI-RS indices for indicating an uplink beam (e.g., a narrow beam for uplink) based on measurement information of the one or more CSI-RSs for uplink beam refinement.

As shown by reference number 820, the UE 220 may transmit, and the network node 210 may receive, a random access message that includes an uplink beam indication (e.g., an indication of the one or more CSI-RS indices for indicating an uplink beam) and a downlink beam indication (e.g., an indication of the one or more CSI-RS indices for indicating a downlink beam). As a result, the UE 220 may indicate narrow beam indications during the random access procedure. As shown by reference number 825, the network node 210 may transmit, and the UE 220 may receive, an indication to apply the uplink beam and the downlink beam. This enables the network node 210 and the UE 220 to communicate using the narrow beams starting at a time 830, thereby reducing the delay associated with communicating using the narrow beams.

As indicated above, FIG. 8 is provided as an example. Other examples may differ from what is described with respect to FIG. 8.

FIG. 9 is a diagram illustrating an example process 900 performed, for example, at a network entity or an apparatus of a network entity. Example process 900 is an example where the apparatus or the network entity (e.g., the second network entity 610, a UE 220, the network entity 102, or the network entity 106) performs operations associated with uplink and downlink spatial direction indication during random access.

As shown in FIG. 9, in some aspects, process 900 may include transmitting, during a random access procedure, a first indication of a first SSB index, wherein the first SSB index indicates first spatial direction information for downlink (block 910). For example, the network entity (e.g., using transmission component 1104 or communication manager 1106, depicted in FIG. 11) may transmit, during a random access procedure, a first indication of a first SSB index, wherein the first SSB index indicates first spatial direction information for downlink, as described above.

As further shown in FIG. 9, in some aspects, process 900 may include transmitting, during the random access procedure, a second indication of a second SSB index, wherein the second SSB index indicates second spatial direction information for uplink (block 920). For example, the network entity (e.g., using transmission component 1104 or communication manager 1106, depicted in FIG. 11) may transmit, during the random access procedure, a second indication of a second SSB index, wherein the second SSB index indicates second spatial direction information for uplink, as described above.

Process 900 may include additional aspects, such as any single aspect or any combination of aspects described below or in connection with one or more other processes described elsewhere herein.

In a first aspect, transmitting the first indication of the first SSB index includes transmitting a first random access message during a random access channel occasion that is associated with the first SSB index, and transmitting the second indication of the second SSB index includes transmitting a second random access message that includes the second indication of the second SSB index.

In a second aspect, alone or in combination with the first aspect, process 900 includes receiving, during the random access procedure, an indication to apply the first spatial direction information for the downlink and to apply the second spatial direction information for the uplink.

In a third aspect, alone or in combination with one or more of the first and second aspects, transmitting the first indication of the first SSB index includes transmitting a first random access message that includes the second indication of the second SSB index, and the first random access message includes the second indication of the second SSB index.

In a fourth aspect, alone or in combination with one or more of the first through third aspects, process 900 includes transmitting, during the random access procedure, a second random access message during a random access channel occasion that is associated with a third SSB index, wherein the third SSB index indicates third spatial direction information for the downlink, and wherein transmission of the second random access message occurs prior to transmission of the first random access message.

In a fifth aspect, alone or in combination with one or more of the first through fourth aspects, process 900 includes receiving, during the random access procedure, a third random access message based on the third spatial direction information, wherein reception of the third random access message occurs prior to transmission of the first random access message.

In a sixth aspect, alone or in combination with one or more of the first through fifth aspects, process 900 includes receiving configuration information associated with a first CSI-RS set and a second CSI-RS set, transmitting a third indication of one or more first CSI-RS indices from the first CSI-RS set, wherein the one or more first CSI-RS indices indicate third spatial direction information for the downlink, and transmitting a fourth indication of one or more second CSI-RS indices from the second CSI-RS set, wherein the one or more second CSI-RS indices indicate fourth spatial direction information for the uplink.

In a seventh aspect, alone or in combination with one or more of the first through sixth aspects, the first CSI-RS set is based on the first spatial direction information, and the second CSI-RS set is based on the second spatial direction information.

In an eighth aspect, alone or in combination with one or more of the first through seventh aspects, process 900 includes transmitting, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

In a ninth aspect, alone or in combination with one or more of the first through eighth aspects, the first CSI-RS set is associated with beam refinement for the downlink, and the second CSI-RS set is associated with beam refinement for the uplink.

In a tenth aspect, alone or in combination with one or more of the first through ninth aspects, process 900 includes measuring one or more first CSI-RSs, from the first CSI-RS set, to obtain first measurement information, wherein the one or more first CSI-RS indices are selected based on the first measurement information, and measuring one or more second CSI-RSs, from the second CSI-RS set, to obtain second measurement information, wherein the one or more second CSI-RS indices are selected based on the second measurement information.

In an eleventh aspect, alone or in combination with one or more of the first through tenth aspects, the first spatial direction information indicates a first beam for the downlink, wherein the third spatial direction information indicates a second beam for the downlink, wherein the second beam is refined from the first beam, and wherein the second spatial direction information indicates a third beam for the uplink, wherein the fourth spatial direction information indicates a fourth beam for the uplink, wherein the fourth beam is refined from the third beam.

In a twelfth aspect, alone or in combination with one or more of the first through eleventh aspects, the third indication of the one or more first CSI-RS indices and the fourth indication of the one or more second CSI-RS indices are included in a random access message associated with the random access procedure.

In a thirteenth aspect, alone or in combination with one or more of the first through twelfth aspects, transmitting the first indication of the first SSB index includes transmitting a first random access message using random access resources that are associated with the first SSB index, and a payload of the first random access message includes the second indication of the second SSB index.

In a fourteenth aspect, alone or in combination with one or more of the first through thirteenth aspects, the random access procedure is a two-step random access procedure, and process 900 includes receiving an indication to fallback to a four-step random access procedure, and transmitting, during the four-step random access procedure, a second random access message that includes the second indication of the second SSB index.

In a fifteenth aspect, alone or in combination with one or more of the first through fourteenth aspects, process 900 includes communicating, based on at least one of the first spatial direction information or the second spatial direction information, one or more signals.

In a sixteenth aspect, alone or in combination with one or more of the first through fifteenth aspects, communicating the one or more signals includes transmitting a signal, of the one or more signals, based at least in part on the second spatial direction information.

In a seventeenth aspect, alone or in combination with one or more of the first through sixteenth aspects, communicating the one or more signals includes receiving a signal, of the one or more signals, based at least in part on the first spatial direction information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network entity or an apparatus of a network entity. Example process 1000 is an example where the apparatus or the network entity (e.g., the first network entity 605, a network node 210, the network entity 102, or the network entity 106) performs operations associated with uplink and downlink spatial direction indication during random access.

As shown in FIG. 10, in some aspects, process 1000 may include receiving, during a random access procedure, a first indication of a first SSB index, wherein the first SSB index indicates first spatial direction information for downlink (block 1010). For example, the network entity (e.g., using reception component 1202 or communication manager 1206, depicted in FIG. 12) may receive, during a random access procedure, a first indication of a first SSB index, wherein the first SSB index indicates first spatial direction information for downlink, as described above.

As further shown in FIG. 10, in some aspects, process 1000 may include receiving, during the random access procedure, a second indication of a second SSB index, wherein the second SSB index indicates second spatial direction information for uplink (block 1020). For example, the network entity (e.g., using reception component 1202 or communication manager 1206, depicted in FIG. 12) may receive, during the random access procedure, a second indication of a second SSB index, wherein the second SSB index indicates second spatial direction information for uplink, as described above.

Process 1000 may include additional aspects, such as any single aspect or any combination of aspects described below or in connection with one or more other processes described elsewhere herein.

In a first aspect, receiving the first indication of the first SSB index includes receiving a first random access message during a random access channel occasion that is associated with the first SSB index, and receiving the second indication of the second SSB index includes receiving a second random access message that includes the second indication of the second SSB index.

In a second aspect, alone or in combination with the first aspect, process 1000 includes transmitting, during the random access procedure, an indication to apply the first spatial direction information for the downlink and to apply the second spatial direction information for the uplink.

In a third aspect, alone or in combination with one or more of the first and second aspects, receiving the first indication of the first SSB index includes receiving a first random access message that includes the second indication of the second SSB index, and the first random access message includes the second indication of the second SSB index.

In a fourth aspect, alone or in combination with one or more of the first through third aspects, process 1000 includes receiving, during the random access procedure, a second random access message during a random access channel occasion that is associated with a third SSB index, wherein the third SSB index indicates third spatial direction information for the downlink, and wherein reception of the second random access message occurs prior to reception of the first random access message.

In a fifth aspect, alone or in combination with one or more of the first through fourth aspects, process 1000 includes transmitting, during the random access procedure, a third random access message based on the third spatial direction information, wherein transmission of the third random access message occurs prior to reception of the first random access message.

In a sixth aspect, alone or in combination with one or more of the first through fifth aspects, process 1000 includes transmitting configuration information associated with a first CSI-RS set and a second CSI-RS set, receiving a third indication of one or more first CSI-RS indices from the first CSI-RS set, wherein the one or more first CSI-RS indices indicate third spatial direction information for the downlink, and receiving a fourth indication of one or more second CSI-RS indices from the second CSI-RS set, wherein the one or more second CSI-RS indices indicate fourth spatial direction information for the uplink.

In a seventh aspect, alone or in combination with one or more of the first through sixth aspects, the first CSI-RS set is based on the first spatial direction information, and the second CSI-RS set is based on the second spatial direction information.

In an eighth aspect, alone or in combination with one or more of the first through seventh aspects, process 1000 includes receiving, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

In a ninth aspect, alone or in combination with one or more of the first through eighth aspects, the first CSI-RS set is associated with beam refinement for the downlink, and the second CSI-RS set is associated with beam refinement for the uplink.

In a tenth aspect, alone or in combination with one or more of the first through ninth aspects, the first spatial direction information indicates a first beam for the downlink, wherein the third spatial direction information indicates a second beam for the downlink, wherein the second beam is refined from the first beam, and wherein the second spatial direction information indicates a third beam for the uplink, wherein the fourth spatial direction information indicates a fourth beam for the uplink, wherein the fourth beam is refined from the third beam.

In an eleventh aspect, alone or in combination with one or more of the first through tenth aspects, the third indication of the one or more first CSI-RS indices and the fourth indication of the one or more second CSI-RS indices are included in a random access message associated with the random access procedure.

In a twelfth aspect, alone or in combination with one or more of the first through eleventh aspects, receiving the first indication of the first SSB index includes receiving a first random access message using random access resources that are associated with the first SSB index, and a payload of the first random access message includes the second indication of the second SSB index.

In a thirteenth aspect, alone or in combination with one or more of the first through twelfth aspects, the random access procedure is a two-step random access procedure, and process 1000 includes transmitting an indication to fallback to a four-step random access procedure based on a decoding failure of the payload, and receiving, during the four-step random access procedure, a second random access message that includes the second indication of the second SSB index.

In a fourteenth aspect, alone or in combination with one or more of the first through thirteenth aspects, process 1000 includes communicating, based on at least one of the first spatial direction information or the second spatial direction information, one or more signals.

In a fifteenth aspect, alone or in combination with one or more of the first through fourteenth aspects, communicating the one or more signals includes receiving a signal, of the one or more signals, based at least in part on the second spatial direction information.

In a sixteenth aspect, alone or in combination with one or more of the first through fifteenth aspects, communicating the one or more signals includes transmitting a signal, of the one or more signals, based at least in part on the first spatial direction information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a network entity, or a network entity may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 114, the communication manager 118, or the communication manager 250. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 110, the processing system 112, or the processing system 240).

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9, or a combination thereof. In some aspects, the apparatus 1100 or one or more components shown in FIG. 11 may include one or more components described in connection with FIG. 1-2. Additionally, or alternatively, one or more components shown in FIG. 11 may be implemented within one or more components described in connection with FIG. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components described above in connection with FIG. 1, such as a radio, one or more RF chains, one or more transceivers, or one or more modems, each of which may in turn be coupled with one or more antennas.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components described above in connection with FIG. 1, such as a radio, one or more RF chains, one or more transceivers, or one or more modems, each of which may in turn be coupled with one or more antennas described in connection with FIG. 1-2. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The transmission component 1104 may transmit, during a random access procedure, a first indication of a first SSB index, wherein the first SSB index indicates first spatial direction information for downlink. The transmission component 1104 may transmit, during the random access procedure, a second indication of a second SSB index, wherein the second SSB index indicates second spatial direction information for uplink.

The reception component 1102 may receive, during the random access procedure, an indication to apply the first spatial direction information for the downlink and to apply the second spatial direction information for the uplink.

The transmission component 1104 may transmit, during the random access procedure, a second random access message during a random access channel occasion that is associated with a third SSB index, wherein the third SSB index indicates third spatial direction information for the downlink, and wherein transmission of the second random access message occurs prior to transmission of the first random access message.

The reception component 1102 may receive, during the random access procedure, a third random access message based on the third spatial direction information, wherein reception of the third random access message occurs prior to transmission of the first random access message.

The reception component 1102 may receive configuration information associated with a first CSI-RS set and a second CSI-RS set.

The transmission component 1104 may transmit a third indication of one or more first CSI-RS indices from the first CSI-RS set, wherein the one or more first CSI-RS indices indicate third spatial direction information for the downlink.

The transmission component 1104 may transmit a fourth indication of one or more second CSI-RS indices from the second CSI-RS set, wherein the one or more second CSI-RS indices indicate fourth spatial direction information for the uplink.

The transmission component 1104 may transmit, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

The communication manager 1106 may measure one or more first CSI-RSs, from the first CSI-RS set, to obtain first measurement information, wherein the one or more first CSI-RS indices are selected based on the first measurement information.

The communication manager 1106 may measure one or more second CSI-RSs, from the second CSI-RS set, to obtain second measurement information, wherein the one or more second CSI-RS indices are selected based on the second measurement information.

The communication manager 1106 may communicate, based on at least one of the first spatial direction information or the second spatial direction information, one or more signals.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1106 is the communication manager 114, the communication manager 118, or the communication manager 255. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 110, the processing system 112, or the processing system 245).

In some aspects, the apparatus 1100 may be configured to perform one or more operations described herein in connection with FIGS. 6-8. Additionally, or alternatively, the apparatus 1100 may be configured to perform one or more processes described herein, such as process 1000 of FIG. 10, or a combination thereof. In some aspects, the apparatus 1200 or one or more components shown in FIG. 12 may include one or more components described in connection with FIG. 1-2. Additionally, or alternatively, one or more components shown in FIG. 12 may be implemented within one or more components described in connection with FIG. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components described above in connection with FIG. 1, such as a radio, one or more RF chains, one or more transceivers, or one or more modems, each of which may in turn be coupled with one or more antennas.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components described above in connection with FIG. 1, such as a radio, one or more RF chains, one or more transceivers, or one or more modems, each of which may in turn be coupled with one or more antennas described in connection with FIG. 1-2. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The reception component 1202 may receive, during a random access procedure, a first indication of a first SSB index, wherein the first SSB index indicates first spatial direction information for downlink. The reception component 1202 may receive, during the random access procedure, a second indication of a second SSB index, wherein the second SSB index indicates second spatial direction information for uplink.

The transmission component 1204 may transmit, during the random access procedure, an indication to apply the first spatial direction information for the downlink and to apply the second spatial direction information for the uplink.

The reception component 1202 may receive, during the random access procedure, a second random access message during a random access channel occasion that is associated with a third SSB index, wherein the third SSB index indicates third spatial direction information for the downlink, and wherein reception of the second random access message occurs prior to reception of the first random access message.

The transmission component 1204 may transmit, during the random access procedure, a third random access message based on the third spatial direction information, wherein transmission of the third random access message occurs prior to reception of the first random access message.

The transmission component 1204 may transmit configuration information associated with a first CSI-RS set and a second CSI-RS set.

The reception component 1202 may receive a third indication of one or more first CSI-RS indices from the first CSI-RS set, wherein the one or more first CSI-RS indices indicate third spatial direction information for the downlink.

The reception component 1202 may receive a fourth indication of one or more second CSI-RS indices from the second CSI-RS set, wherein the one or more second CSI-RS indices indicate fourth spatial direction information for the uplink.

The reception component 1202 may receive, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

The communication manager 1206 may communicate, based on at least one of the first spatial direction information or the second spatial direction information, one or more signals.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a network entity, comprising: transmitting, during a random access procedure, a first indication of a first synchronization signal block (SSB) index, wherein the first SSB index indicates first spatial direction information for downlink; and transmitting, during the random access procedure, a second indication of a second SSB index, wherein the second SSB index indicates second spatial direction information for uplink.

Aspect 2: The method of Aspect 1, wherein transmitting the first indication of the first SSB index comprises: transmitting a first random access message during a random access channel occasion that is associated with the first SSB index; and wherein transmitting the second indication of the second SSB index comprises: transmitting a second random access message that includes the second indication of the second SSB index.

Aspect 3: The method of any of Aspects 1-2, further comprising receiving, during the random access procedure, an indication to apply the first spatial direction information for the downlink and to apply the second spatial direction information for the uplink.

Aspect 4: The method of any of Aspects 1-3, wherein transmitting the first indication of the first SSB index comprises: transmitting a first random access message that includes the second indication of the second SSB index, and wherein the first random access message includes the second indication of the second SSB index.

Aspect 5: The method of Aspect 4, further comprising: transmitting, during the random access procedure, a second random access message during a random access channel occasion that is associated with a third SSB index, wherein the third SSB index indicates third spatial direction information for the downlink, and wherein transmission of the second random access message occurs prior to transmission of the first random access message.

Aspect 6: The method of Aspect 5, further comprising: receiving, during the random access procedure, a third random access message based on the third spatial direction information, wherein reception of the third random access message occurs prior to transmission of the first random access message.

Aspect 7: The method of any of Aspects 1-6, further comprising: receiving configuration information associated with a first channel state information (CSI) reference signal (CSI-RS) set and a second CSI-RS set; transmitting a third indication of one or more first CSI-RS indices from the first CSI-RS set, wherein the one or more first CSI-RS indices indicate third spatial direction information for the downlink; and transmitting a fourth indication of one or more second CSI-RS indices from the second CSI-RS set, wherein the one or more second CSI-RS indices indicate fourth spatial direction information for the uplink.

Aspect 8: The method of Aspect 7, wherein the first CSI-RS set is based on the first spatial direction information, and wherein the second CSI-RS set is based on the second spatial direction information.

Aspect 9: The method of any of Aspects 7-8, further comprising: transmitting, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

Aspect 10: The method of any of Aspects 7-9, wherein the first CSI-RS set is associated with beam refinement for the downlink, and wherein the second CSI-RS set is associated with beam refinement for the uplink.

Aspect 11: The method of any of Aspects 7-10, further comprising: measuring one or more first CSI-RSs, from the first CSI-RS set, to obtain first measurement information, wherein the one or more first CSI-RS indices are selected based on the first measurement information; and measuring one or more second CSI-RSs, from the second CSI-RS set, to obtain second measurement information, wherein the one or more second CSI-RS indices are selected based on the second measurement information.

Aspect 12: The method of any of Aspects 7-11, wherein the first spatial direction information indicates a first beam for the downlink, wherein the third spatial direction information indicates a second beam for the downlink, wherein the second beam is refined from the first beam; and wherein the second spatial direction information indicates a third beam for the uplink, wherein the fourth spatial direction information indicates a fourth beam for the uplink, wherein the fourth beam is refined from the third beam.

Aspect 13: The method of any of Aspects 7-12, wherein the third indication of the one or more first CSI-RS indices and the fourth indication of the one or more second CSI-RS indices are included in a random access message associated with the random access procedure.

Aspect 14: The method of any of Aspects 1-13, wherein transmitting the first indication of the first SSB index comprises: transmitting a first random access message using random access resources that are associated with the first SSB index, and wherein a payload of the first random access message includes the second indication of the second SSB index.

Aspect 15: The method of Aspect 14, wherein the random access procedure is a two-step random access procedure, and the method further comprising: receiving an indication to fallback to a four-step random access procedure; and transmitting, during the four-step random access procedure, a second random access message that includes the second indication of the second SSB index.

Aspect 16: The method of any of Aspects 1-15, further comprising communicating, based on at least one of the first spatial direction information or the second spatial direction information, one or more signals.

Aspect 17: The method of Aspect 16, wherein communicating the one or more signals comprises transmitting a signal, of the one or more signals, based at least in part on the second spatial direction information.

Aspect 18: The method of Aspect 16, wherein communicating the one or more signals comprises receiving a signal, of the one or more signals, based at least in part on the first spatial direction information.

Aspect 19: A method of wireless communication performed by a network entity, comprising: receiving, during a random access procedure, a first indication of a first synchronization signal block (SSB) index, wherein the first SSB index indicates first spatial direction information for downlink; and receiving, during the random access procedure, a second indication of a second SSB index, wherein the second SSB index indicates second spatial direction information for uplink.

Aspect 20: The method of Aspect 19, wherein receiving the first indication of the first SSB index comprises: receiving a first random access message during a random access channel occasion that is associated with the first SSB index; and wherein receiving the second indication of the second SSB index comprises: receiving a second random access message that includes the second indication of the second SSB index.

Aspect 21: The method of any of Aspects 19-20, further comprising: transmitting, during the random access procedure, an indication to apply the first spatial direction information for the downlink and to apply the second spatial direction information for the uplink.

Aspect 22: The method of any of Aspects 19-21, wherein receiving the first indication of the first SSB index comprises: receiving a first random access message that includes the second indication of the second SSB index, and wherein the first random access message includes the second indication of the second SSB index.

Aspect 23: The method of Aspect 22, further comprising: receiving, during the random access procedure, a second random access message during a random access channel occasion that is associated with a third SSB index, wherein the third SSB index indicates third spatial direction information for the downlink, and wherein reception of the second random access message occurs prior to reception of the first random access message.

Aspect 24: The method of Aspect 23, further comprises: transmitting, during the random access procedure, a third random access message based on the third spatial direction information, wherein transmission of the third random access message occurs prior to reception of the first random access message.

Aspect 25: The method of any of Aspects 19-24, further comprising: transmitting configuration information associated with a first channel state information (CSI) reference signal (CSI-RS) set and a second CSI-RS set; receiving a third indication of one or more first CSI-RS indices from the first CSI-RS set, wherein the one or more first CSI-RS indices indicate third spatial direction information for the downlink; and receiving a fourth indication of one or more second CSI-RS indices from the second CSI-RS set, wherein the one or more second CSI-RS indices indicate fourth spatial direction information for the uplink.

Aspect 26: The method of Aspect 25, wherein the first CSI-RS set is based on the first spatial direction information, and wherein the second CSI-RS set is based on the second spatial direction information.

Aspect 27: The method of any of Aspects 25-26, further comprising: receiving, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

Aspect 28: The method of any of Aspects 25-27, wherein the first CSI-RS set is associated with beam refinement for the downlink, and wherein the second CSI-RS set is associated with beam refinement for the uplink.

Aspect 29: The method of any of Aspects 25-28, wherein the first spatial direction information indicates a first beam for the downlink, wherein the third spatial direction information indicates a second beam for the downlink, wherein the second beam is refined from the first beam; and wherein the second spatial direction information indicates a third beam for the uplink, wherein the fourth spatial direction information indicates a fourth beam for the uplink, wherein the fourth beam is refined from the third beam.

Aspect 30: The method of any of Aspects 25-29, wherein the third indication of the one or more first CSI-RS indices and the fourth indication of the one or more second CSI-RS indices are included in a random access message associated with the random access procedure.

Aspect 31: The method of any of Aspects 19-30, wherein receiving the first indication of the first SSB index comprises: receiving a first random access message using random access resources that are associated with the first SSB index, and wherein a payload of the first random access message includes the second indication of the second SSB index.

Aspect 32: The method of Aspect 31, wherein the random access procedure is a two-step random access procedure, and the method further comprising: transmitting an indication to fallback to a four-step random access procedure based on a decoding failure of the payload; and receiving, during the four-step random access procedure, a second random access message that includes the second indication of the second SSB index.

Aspect 33: The method of any of Aspects 19-32, further comprising: communicating, based on at least one of the first spatial direction information or the second spatial direction information, one or more signals.

Aspect 34: The method of Aspect 33, wherein communicating the one or more signals comprises receiving a signal, of the one or more signals, based at least in part on the second spatial direction information.

Aspect 35: The method of Aspect 33, wherein communicating the one or more signals comprises transmitting a signal, of the one or more signals, based at least in part on the first spatial direction information.

Aspect 36: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-35.

Aspect 37: An apparatus for wireless communication at a device, the apparatus comprising one or more memories and one or more processors coupled to the one or more memories, the one or more processors configured to cause the device to perform the method of one or more of Aspects 1-35.

Aspect 38: An apparatus for wireless communication, the apparatus comprising at least one means for performing the method of one or more of Aspects 1-35.

Aspect 39: A non-transitory computer-readable medium storing code for wireless communication, the code comprising instructions executable by one or more processors to perform the method of one or more of Aspects 1-35.

Aspect 40: A non-transitory computer-readable medium storing a set of instructions for wireless communication, the set of instructions comprising one or more instructions that, when executed by one or more processors of a device, cause the device to perform the method of one or more of Aspects 1-35.

Aspect 41: A device for wireless communication, the device comprising a processing system that includes one or more processors and one or more memories coupled with the one or more processors, the processing system configured to cause the device to perform the method of one or more of Aspects 1-35.

Aspect 42: An apparatus for wireless communication at a device, the apparatus comprising one or more memories and one or more processors coupled to the one or more memories, the one or more processors individually or collectively configured to cause the device to perform the method of one or more of Aspects 1-35.

Aspect 43: A device comprising a processing system that includes one or more processors and one or more code-storing memories coupled with the one or more processors, the processing system configured to cause the device to perform the method of one or more of Aspects 1-35.

Aspect 44: A device comprising a processing system that includes processor circuitry and code-storing memory circuitry, the processing system configured to cause the device to perform the method of one or more of Aspects 1-35.

Aspect 45: A device for wireless communication, the device comprising a processing system, the processing system configured to perform the method of one or more of Aspects 1-35.

Aspect 46: A non-transitory computer-readable medium having code thereon that, when executed by a device, causes the device to perform the method of one or more of Aspects 1-35.

Systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network entity, comprising:
a processing system configured to:
transmit, during a random access procedure, a first indication of a first synchronization signal block (SSB) index, wherein the first SSB index indicates first spatial direction information for downlink; and
transmit, during the random access procedure, a second indication of a second SSB index, wherein the second SSB index indicates second spatial direction information for uplink.

2. The network entity of claim 1, wherein, to transmit the first indication of the first SSB index, the processing system is configured to:
transmit a first random access message during a random access channel occasion that is associated with the first SSB index; and
wherein, to transmit the second indication of the second SSB index, the processing system is configured to:
transmit a second random access message that includes the second indication of the second SSB index.

3. The network entity of claim 1, wherein the processing system is configured to receive, during the random access procedure, an indication to apply the first spatial direction information for the downlink and to apply the second spatial direction information for the uplink.

4. The network entity of claim 1, wherein, to transmit the first indication of the first SSB index, the processing system is configured to:
transmit a first random access message that includes the second indication of the second SSB index, and wherein the first random access message includes the second indication of the second SSB index.

5. The network entity of claim 4, wherein the processing system is configured to:
transmit, during the random access procedure, a second random access message during a random access channel occasion that is associated with a third SSB index, wherein the third SSB index indicates third spatial direction information for the downlink, and wherein transmission of the second random access message occurs prior to transmission of the first random access message.

6. The network entity of claim 5, wherein the processing system is configured to receive, during the random access procedure, a third random access message based on the third spatial direction information, wherein reception of the third random access message occurs prior to transmission of the first random access message.

7. The network entity of claim 1, wherein the processing system is configured to:
receive configuration information associated with a first channel state information (CSI) reference signal (CSI-RS) set and a second CSI-RS set;
transmit a third indication of one or more first CSI-RS indices from the first CSI-RS set, wherein the one or more first CSI-RS indices indicate third spatial direction information for the downlink; and
transmit a fourth indication of one or more second CSI-RS indices from the second CSI-RS set, wherein the one or more second CSI-RS indices indicate fourth spatial direction information for the uplink.

8. The network entity of claim 7, wherein the first CSI-RS set is based on the first spatial direction information, and wherein the second CSI-RS set is based on the second spatial direction information.

9. The network entity of claim 7, wherein the processing system is configured to transmit, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

10. The network entity of claim 7, wherein the first CSI-RS set is associated with beam refinement for the downlink, and wherein the second CSI-RS set is associated with beam refinement for the uplink.

11. The network entity of claim 7, wherein the processing system is configured to:
measure one or more first CSI-RSs, from the first CSI-RS set, to obtain first measurement information, wherein the one or more first CSI-RS indices are selected based on the first measurement information; and
measure one or more second CSI-RSs, from the second CSI-RS set, to obtain second measurement information, wherein the one or more second CSI-RS indices are selected based on the second measurement information.

12. The network entity of claim 7, wherein the first spatial direction information indicates a first beam for the downlink, wherein the third spatial direction information indicates a second beam for the downlink, wherein the second beam is refined from the first beam; and
wherein the second spatial direction information indicates a third beam for the uplink,
wherein the fourth spatial direction information indicates a fourth beam for the uplink,
wherein the fourth beam is refined from the third beam.

13. The network entity of claim 7, wherein the third indication of the one or more first CSI-RS indices and the fourth indication of the one or more second CSI-RS indices are included in a random access message associated with the random access procedure.

14. The network entity of claim 1, wherein, to transmit the first indication of the first SSB index, the processing system is configured to:
transmit a first random access message using random access resources that are associated with the first SSB index, and wherein a payload of the first random access message includes the second indication of the second SSB index.

15. The network entity of claim 14, wherein the random access procedure is a two-step random access procedure, and wherein the processing system is configured to:
receive an indication to fallback to a four-step random access procedure; and
transmit, during the four-step random access procedure, a second random access message that includes the second indication of the second SSB index.

16. The network entity of claim 1, wherein the processing system is configured to communicate, based on at least one of the first spatial direction information or the second spatial direction information, one or more signals.

17. The network entity of claim 16, wherein, to communicate the one or more signals, the processing system is configured to transmit a signal, of the one or more signals, based at least in part on the second spatial direction information.

18. The network entity of claim 16, wherein, to communicate the one or more signals, the processing system is configured to receive a signal, of the one or more signals, based at least in part on the first spatial direction information.

19. A network entity, comprising:
a processing system configured to:
receive, during a random access procedure, a first indication of a first synchronization signal block (SSB) index, wherein the first SSB index indicates first spatial direction information for downlink; and
receive, during the random access procedure, a second indication of a second SSB index, wherein the second SSB index indicates second spatial direction information for uplink.

20. The network entity of claim 19, wherein, to receive the first indication of the first SSB index, the processing system is configured to:
receive a first random access message during a random access channel occasion that is associated with the first SSB index; and
wherein, to receive the second indication of the second SSB index, the processing system is configured to:
receive a second random access message that includes the second indication of the second SSB index.

21. The network entity of claim 19, wherein the processing system is configured to transmit, during the random access procedure, an indication to apply the first spatial direction information for the downlink and to apply the second spatial direction information for the uplink.

22. The network entity of claim 19, wherein, to receive the first indication of the first SSB index, the processing system is configured to:
receive a first random access message that includes the second indication of the second SSB index, and wherein the first random access message includes the second indication of the second SSB index.

23. The network entity of claim 19, wherein the processing system is configured to:
transmit configuration information associated with a first channel state information (CSI) reference signal (CSI-RS) set and a second CSI-RS set;
receive a third indication of one or more first CSI-RS indices from the first CSI-RS set, wherein the one or more first CSI-RS indices indicate third spatial direction information for the downlink; and
receive a fourth indication of one or more second CSI-RS indices from the second CSI-RS set, wherein the one or more second CSI-RS indices indicate fourth spatial direction information for the uplink.

24. The network entity of claim 23, wherein the processing system is configured to receive, during the random access procedure, a random access message during a random access channel occasion that is associated with a third SSB index, wherein the third SSB index indicates fifth spatial direction information for the downlink, wherein the first CSI-RS set and the second CSI-RS set are a single CSI-RS set, and wherein the single CSI-RS set is based on the fifth spatial direction information.

25. The network entity of claim 23, wherein the first CSI-RS set is associated with beam refinement for the downlink, and wherein the second CSI-RS set is associated with beam refinement for the uplink.
